(19) United States
(12) Patent Application Publication
(10) Pub. No.: US 2025/0106905 A1
(43) Pub. Date: Mar. 27, 2025

(54) BLUETOOTH LOW ENERGY COEXISTENCE LINK CONFIGURATION

(71) Applicant: QUALCOMM Incorporated, San Diego, CA (US)

(72) Inventors: Olaf Josef HIRSCH, Sunnyvale, CA (US); Kiran NEELISETTY, Tracy, CA (US); Eric TSOU, Palo Alto, CA (US); Laurent WOJCIESZAK, Belfast (GB); Jonathan Grenville TANNER, Sidmouth (GB); Srinivasa Rao UPPALA, Hyderabad (IN)

(21) Appl. No.: 18/729,476

(22) PCT Filed: Mar. 8, 2023
(86) PCT No.: PCT/US2023/063943

§ 371 Date: Jul. 16, 2024

(30) Foreign Application Priority Data
Mar. 28, 2022 (IN) 202241017763

(51) Int. Cl. H04W 74/0833; H04W 24/02; H04W 84/12

(52) U.S. Cl. CPC H04W 74/0841; H04W 24/02; H04W 84/12

(57) ABSTRACT

Various aspects of the present disclosure generally relate to wireless communication. In some aspects, a wireless communication device may configure a short-range wireless communication link for use by a first communication technology, wherein a configuration of the short-range wireless communication link includes a number of configured retransmission opportunities to support multiple coexistence transmission patterns associated with the first communication technology and a second communication technology. The wireless communication device may transmit, to another wireless communication device, a communication using at least one of the first communication technology and the second communication technology based at least in part on a selected coexistence transmission pattern, of the multiple coexistence transmission patterns. Numerous other aspects are described.

### CROSS-REFERENCE TO RELATED APPLICATION

This patent application claims priority to India Patent Application No. 202241017763, filed on Mar. 28, 2022, entitled “BLUETOOTH LOW ENERGY COEXISTENCE LINK CONFIGURATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for Bluetooth low energy coexistence link configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP). Multi-access technologies may also include New Radio (NR) 5G or 6G.

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B (NB), a gNB, an access point (AP), a radio head, a transmit receive point (TRP), a New Radio (NR) BS, or a 5G Node B.

The UE may operate with peripheral devices (e.g., earbuds, smart watches) using short-range wireless communication. Short-range wireless communication enables wireless communication over relatively short distances (e.g., within 30 meters). Bluetooth protocols are an example of a wireless technology standard for exchanging data over short distances using short-wavelength ultra high frequency (UHF) radio waves from 2.4 gigahertz (GHz) to 2.485 GHz. Bluetooth Low Energy (BLE) protocol is for communication with devices running on low power. Various other short-range wireless communication technologies may operate in a similar wavelength, such as wireless local area network (WLAN) technologies.

More particularly, wireless devices operating in the “Bluetooth” wireless communication spectrum (using the BLE protocol or a similar protocol, such as a “classic” or “legacy” Bluetooth protocol, or the like) are proliferating. In particular, the term “Bluetooth” generally refers to and defines a relatively short range wireless communication protocol, with an operating range ranging from a few meters to a few tens of meters. The Bluetooth specification includes various profiles that define the behavior associated with each communication endpoint to implement a specific use case. Several such use cases are contemplated in the Bluetooth specification, which are generally defined according to a protocol stack that promotes and allows interoperability between endpoint devices from different manufacturers through enabling applications to discover and use services that other nearby Bluetooth devices may be offering.

As the demand for short-range wireless communication technologies continues to increase, further improvements in BLE and various other short-range wireless communication technologies remain useful.

### SUMMARY

Some aspects described herein relate to a method of wireless communication performed by a wireless communication device. The method may include configuring a short-range wireless communication link for use by a first communication technology, wherein a configuration of the short-range wireless communication link includes a number of configured retransmission opportunities to support multiple coexistence transmission patterns associated with the first communication technology and a second communication technology. The method may include transmitting, to another wireless communication device, a communication using at least one of the first communication technology and the second communication technology based at least in part on a selected coexistence transmission pattern, of the multiple coexistence transmission patterns.

Some aspects described herein relate to a wireless communication device for wireless communication. The wireless communication device may include a memory and one or more processors coupled to the memory. The one or more processors may be configured to configure a short-range wireless communication link for use by a first communication technology, wherein a configuration of the short-range wireless communication link includes a number of configured retransmission opportunities to support multiple coexistence transmission patterns associated with the first communication technology and a second communication technology. The one or more processors may be configured to transmit, to another wireless communication device, a communication using at least one of the first communication technology and the second communication technology based at least in part on a selected coexistence transmission pattern, of the multiple coexistence transmission patterns.

Some aspects described herein relate to a non-transitory computer-readable medium that stores a set of instructions for wireless communication by a wireless communication device. The set of instructions, when executed by one or more processors of the wireless communication device, may cause the wireless communication device to configure a short-range wireless communication link for use by a first communication technology, wherein a configuration of the short-range wireless communication link includes a number of configured retransmission opportunities to support multiple coexistence transmission patterns associated with the first communication technology and a second communication technology. The set of instructions, when executed by one or more processors of the wireless communication device, may cause the wireless communication device to transmit, to another wireless communication device, a communication using at least one of the first communication technology and the second communication technology based at least in part on a selected coexistence transmission pattern, of the multiple coexistence transmission patterns.

Some aspects described herein relate to an apparatus for wireless communication. The apparatus may include means for configuring a short-range wireless communication link for use by a first communication technology, wherein a configuration of the short-range wireless communication link includes a number of configured retransmission opportunities to support multiple coexistence transmission patterns associated with the first communication technology and a second communication technology. The apparatus may include means for transmitting, to a wireless communication device, a communication using at least one of the first communication technology and the second communication technology based at least in part on a selected coexistence transmission pattern, of the multiple coexistence transmission patterns.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a Bluetooth communication technology, in accordance with the present disclosure.

FIG. 2 is a diagram illustrating an example of an implementation using the Bluetooth protocol stack to support one or more logical connections, in accordance with the present disclosure.

FIG. 3 is a diagram illustrating an example of dependency relationships associated with a Generic Attribute Profile on which all application profiles are based in Bluetooth Low Energy, in accordance with the present disclosure.

FIG. 4 is a diagram illustrating an example of a Bluetooth generic data transport architecture, in accordance with the present disclosure.

FIGS. 5-9 are diagrams illustrating examples of a short-range wireless communication links, in accordance with the present disclosure.

FIG. 10 is a diagram illustrating an example associated with Bluetooth low energy coexistence link configuration, in accordance with the present disclosure.

FIG. 11 is a diagram illustrating an example process performed, for example, by a wireless communication device, in accordance with the present disclosure.

FIG. 12 is a diagram illustrating an example apparatus for wireless communication, in accordance with the present disclosure.

FIG. 13 is a diagram illustrating an example of a wireless communication device, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with short-range wireless communication protocols, aspects of the present disclosure can be applied to other protocols or radio access technologies (RATs), such as a 3G RAT, a 4G RAT, a 5G or New Radio (NR) RAT, and/or a RAT subsequent to 5G (e.g., 6G).

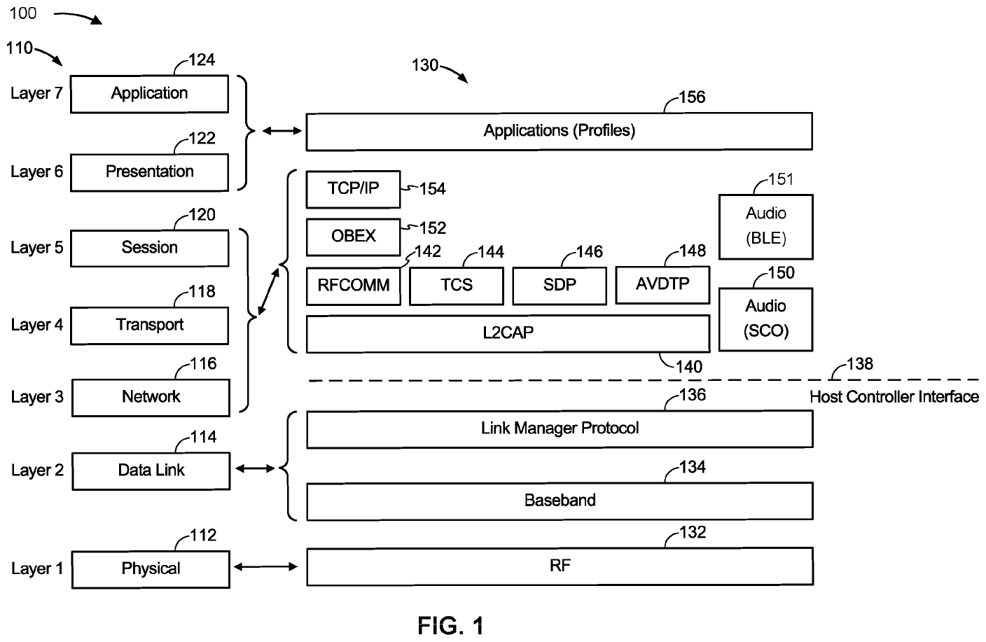

FIG. 1 is a diagram illustrating an example 100 of a Bluetooth communication technology, in accordance with the present disclosure.

More particularly, FIG. 1 illustrates a relationship between the Bluetooth protocol stack 130 and the seven layers in the Open Systems Interconnect (OSI) model 110, which was established to standardize information transmission between points over the Internet or other wired and/or wireless networks. In particular, the OSI model 110 generally separates communications processes between two points in a network into seven stacked layers, with each layer adding certain functions. Each device handles a message such that a downward flow through each layer occurs at a sending endpoint and an upward flow through the layers occurs at a receiving endpoint. The programming and/or hardware that provides the seven layers in the OSI model 110 is typically a combination of device operating systems, application software, transmission control protocol (TCP)/Internet protocol (IP) and/or other transport and network protocols, and other software and hardware.

More particularly, referring to FIG. 1, the OSI model 110 includes a physical layer 112 (OSI Layer 1) used to convey a bit stream through a network at a physical level. The Institute of Electrical and Electronics Engineers (IEEE) sub-divides the physical layer 112 into the PLCP (Physical Layer Convergence Procedure) sub-layer and the PMD (Physical Medium Dependent) sub-layer. The data link layer 114 (OSI Layer 2) provides physical level synchronization, performs bit-stuffing, and furnishes transmission protocol knowledge and management, or the like. The IEEE sub-divides the data link layer 114 into two further sub-layers, which comprise the Media Access Control (MAC) sub-layer to control data transfer to and from the physical layer and the Logical Link Control (LLC) sub-layer to interface with the network layer 116 (OSI Layer 3), interpret commands, and perform error recovery.

The network layer 116 (OSI Layer 3) handles data transfer across a network (e.g., routing and forwarding) in a manner independent from any media and specific network topology, the transport layer 118 (OSI Layer 4) manages end-to-end control and error-checking to multiplex data transfer across the network according to application-level reliability requirements, and the session layer 120 (OSI Layer 5) establishes, coordinates, and terminates conversations, exchanges, and dialogs between the applications to provide management and data flow control services.

The presentation layer 122 (OSI Layer 6) converts incoming and outgoing data from one presentation format to another, which may comprise adding service structure to the data units to provide data to the application layer 124 (OSI Layer 7) according to a common representation, while the application layer 124 is where communication partners are identified, quality of service (QoS) is identified, user authentication and privacy are considered, constraints on data syntax are identified, and any other functions relevant to managing communications between host applications are managed.

Turning now to the Bluetooth protocol stack 130, the radio frequency (RF) layer 132 generally corresponds to the physical layer 112 in the OSI model 110, the baseband layer 134 and the link manager protocol layer 136 generally correspond to the data link layer 114, and a Host Controller Interface (HCl) 138 separates the RF layer 132, the baseband layer 134, and the link manager protocol layer 136 from the upper layers. For example, the Physical Layer 112 in the OSI model 110 manages electrical interfaces to communications media, which includes modulation and channel coding, and therefore covers the Bluetooth radio in the RF layer 132 (and possibly part of the baseband layer 134), while the data link layer 114 manages transmission, framing, and error control over a particular link, which overlaps tasks performed in the link manager protocol layer 136 and the control end of the baseband layer 134 (e.g., error checking and correction).

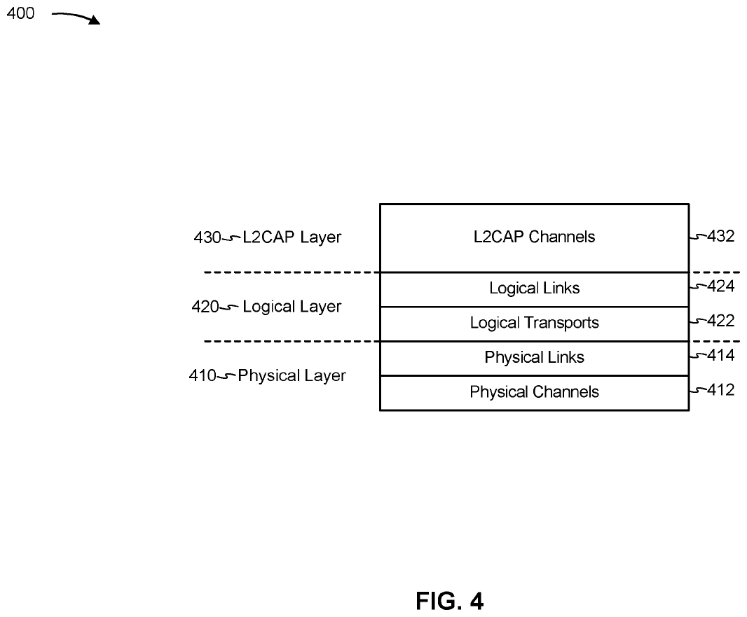

Above the HCl 138, the Logical Link Control and Adaptation Protocol (L2CAP) 140, RF communication (RFCOMM) channel 142, Telephony Control Specification (TCS) 144, Service Discovery Protocol (SDP) 146, Audio/Video Distribution Transport Protocol (AVDTP) 148, Synchronous Connection Oriented (SCO) Audio 150, Bluetooth Low Energy (BLE) Audio 151 (e.g., a Generic Audio Framework), object exchange (OBEX) 152, and TCP/IP 154 functions correspond to the network layer 116, transport layer 118, and session layer 120. The applications layer 156 comprises the Bluetooth profiles (e.g., the Handsfree Profile (HFP) for voice, the Advanced Audio Distribution Profile (A2DP) for high-quality audio streaming, the Video Distribution Profile (VDP) for video streaming, etc.) and corresponds to the presentation layer 122 and the application layer 124 in the OSI model 110. Accordingly, a Bluetooth profile may generally be considered synonymous with an “application” in the OSI seven-layer model 110. In relation to the Bluetooth HFP, the RFCOMM channel 142 comprises a communication channel named “service level connection” (“SLC”) (not shown) that emulates a serial port used for further communication between an Audio Gateway (AG) device and a Handsfree (HF) device. For voice audio connections, such as in the Bluetooth HFP, a separate baseband link called an SCO channel carries the voice data, represented as SCO audio 150 in FIG. 1. For A2DP, the audio data (unidirectional high-quality audio content, which may be in mono or stereo) goes over AVDTP 148, which in turn goes over L2CAP 140. At the radio level, all L2CAP 140 data flows over a logical link, as will be described in further detail below with reference to FIG. 4.

Bluetooth wireless technology systems generally come in two forms, which include Basic Rate (BR) and Low Energy (LE), wherein the former further includes optional Enhanced Data Rate (EDR) Alternate MAC and Physical (PHY) layer extensions. Bluetooth BR systems and BLE systems (e.g., Generic Audio Framework systems) both include device discovery, connection establishment, and connection mechanisms. However, the BLE system includes features designed to enable products that require lower current consumption, lower complexity, and lower cost than BR/EDR and has a design to support use cases and applications with lower data rates and lower duty cycles. In general, depending on the use case or application, one system including any optional parts may be more optimal than the other. Furthermore, devices implementing both systems can communicate with other devices implementing both systems as well as devices implementing either system. However, some profiles and use cases may only be supported in one system or the other, whereby devices that implement both systems have the ability to support the most use cases. The Bluetooth core system generally comprises a host and one or more controllers, wherein a host is a logical entity defined as all of the layers below the applications layer 156 in which the Bluetooth profiles are implemented and above the HCl 138, while a controller is a logical entity defined as all of the layers below the HCl 138. According to various aspects, a Bluetooth enabled device generally has one primary controller, which may be a BR/EDR controller that includes the RF layer 132, the baseband layer 134, the link manager protocol layer 136, and optionally the HCl 138. Alternatively, the primary controller may be an LE controller that includes the LE PHY, link manager protocol layer 136, and optionally the HCl 138. In a further alternative, the primary controller may combine a BR/EDR portion and a LE controller portion into a single controller, in which case the controller configuration has only one Bluetooth device address shared among the combined BR/EDR and LE controller portions.

As indicated above, FIG. 1 is provided as an example. Other examples may differ from what is described with regard to FIG. 1.

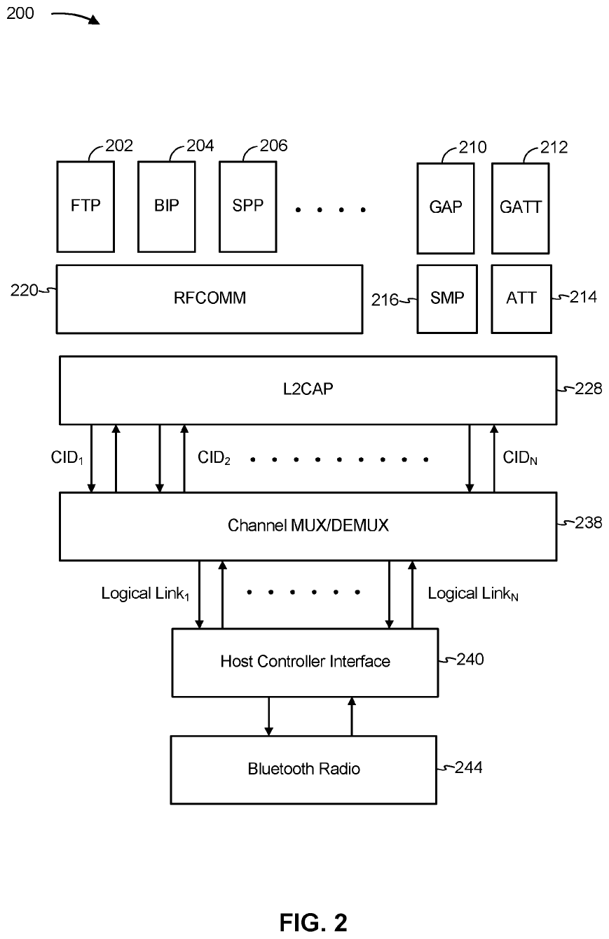

FIG. 2 is a diagram illustrating an example 200 of an implementation using the Bluetooth protocol stack to support one or more logical connections, in accordance with the present disclosure.

For example, the File Transfer Protocol (FTP) 202 provides a method to transfer files without the loss of data, which can include all file types including binary and American standard code for information interchange (ASCII) text, the Basic Imaging Profile (BIP) 204 establishes the fundamental requirements to enable negotiation of the size and encoding of image-related data, the Serial Port Profile (SPP) 206 defines how to set up virtual serial ports and connect two Bluetooth-enabled devices, and the RFCOMM 220 is a protocol based upon the standard for serial port emulation which has been adopted for Bluetooth. Furthermore, as mentioned above, the Bluetooth protocol stack shown at example 200 includes an L2CAP layer 228, which provides multiplexing (MUX) and demultiplexing (DEMUX) capabilities in the Bluetooth protocol stack. For example, the L2CAP layer 228 may establish a Channel ID (CID) link to a MUX/DEMUX sublayer 238, wherein a CID refers to a logical connection on the L2CAP layer 228 between two devices serving a single application or higher layer protocol. The MUX/DEMUX sublayer 238 may operate over a logical link that the baseband layer protocols provide. The HCl 240, upon receipt of data over a logical link, communicates the lower layer protocols to the host device (e.g., a Bluetooth-enabled laptop or mobile phone). The HCl 240 therefore represents the command interface to the baseband controller and provides uniform access to the baseband capabilities controlling the Bluetooth radio 244.

In Bluetooth BR/EDR and BLE implementations, the Bluetooth radio 244 operates in the unlicensed 2.4 GHz ISM band. In BLE implementations, a frequency hopping transceiver is employed to combat interference and fading and provides many Frequency Hopping Spread Spectrum (FHSS) carriers. In BLE, frequency division multiple access (FDMA) and/or time division multiple access (TDMA) schemes may be employed and the physical channel is sub-divided into time units (or “events”) in which packets may be positioned to transmit data between BLE devices. In general, there are two event types, which include advertising and connection events. Devices that transmit the advertising packets on the advertising PHY channels are referred to as advertisers and devices that receive advertising on the advertising channels without the intention to connect to the advertising device are referred to as scanners. Transmissions on the advertising PHY channels occur in advertising events, wherein at the start of each advertising event, the advertiser sends an advertising packet corresponding to the advertising event type. Depending on the advertising packet type, the scanner may make a request to the advertiser on the same advertising PHY channel and a response from the advertiser on the same advertising PHY channel may follow the request. Above the physical channel, links, channels, and associated control protocols are arranged in a hierarchy based on a physical channel, a physical link, a logical transport, a logical link, and an L2CAP channel, as will be described in further detail below with respect to FIG. 4.

In Bluetooth BR/EDR and BLE implementations, the L2CAP layer 228 provides a channel-based abstraction to applications and services, wherein the L2CAP layer 228 fragments and de-fragments application data and multiplexes/de-multiplexes multiple channels over a shared logical link. However, in a BLE implementation, two additional protocol layers that reside above the L2CAP layer 228 are provided. In particular, the Security Manager protocol (SMP) 216 uses a fixed L2CAP channel to implement security functions between devices and the Attribute protocol (ATT) 214 provides a method to communicate small amounts of data over a fixed L2CAP channel. Devices also use the ATT protocol 214 to determine the services and capabilities associated with other devices. The ATT protocol 214 further depends on the Generic Access Profile (GAP) 210, which provides the basis for all other profiles and defines how two Bluetooth-enabled devices discover and establish a connection with each other. The Generic Attribute (GATT) Profile 212 is built on the ATT protocol 214 and defines a service framework to use the ATT protocol 214 according to procedures, formats, and characteristics associated with certain services (e.g., discovering, reading, writing, notifying, and indicating characteristics, configuring broadcast characteristics, etc.). In general, the GAP 210, the GATT profile 212, and the ATT protocol 214 are not transport-specific and can be used in Bluetooth BR/EDR and BLE implementations. However, BLE implementations are required to implement the GATT profile 212 and the ATT protocol 214 because the GATT profile 212 is used to discover services in Bluetooth LE.

As indicated above, FIG. 2 is provided as an example. Other examples may differ from what is described with regard to FIG. 2.

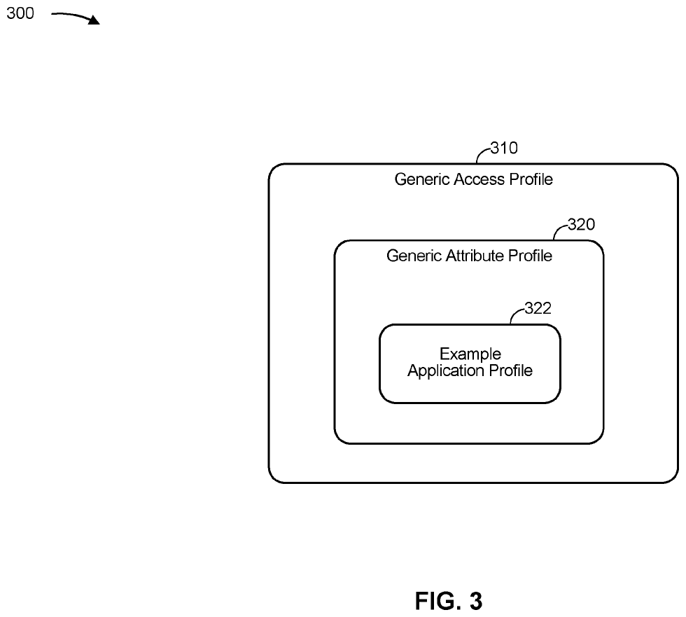

FIG. 3 is a diagram illustrating an example 300 of dependency relationships associated with GATT Profile 320 on which all application profiles 322 are based in BLE, in accordance with the present disclosure.

More particularly, a first profile may generally be considered dependent upon a second profile where the first profile re-uses part of the second profile, which may occur where the first profile implicitly or explicitly references the part of the second profile re-used in the first profile. Accordingly, a profile has dependencies on the profile(s) that contain the profile, whether directly or indirectly. For example, as shown in FIG. 3, the GATT profile 320 depends on the GAP 310, which defines how two Bluetooth units discover and establish a connection with one another to provide the basis for all other Bluetooth profiles. The GATT profile 320 is designed to be used by an application profile 322 such that a client can communicate with a server, wherein the client refers to a role associated with a device that initiates commands and requests towards the server and can receive responses, indications, and notifications sent from the server, while the server refers to a role associated with the device that accepts incoming commands and requests from the client and sends responses, indications, and notifications to the client. However, those skilled in the art will appreciate that the client and server roles are not fixed to the device, as the roles are instead determined when a device initiates a defined procedure and are released when the procedure ends. Accordingly, the device operating in the server role contains various attributes, and the GATT profile 320 defines how to use the ATT to discover, read, write and obtain indications associated with the attributes and to configure broadcasting attributes. With respect to BLE, the Bluetooth Special Interest Group (SIG) has defined several example application profiles 322 that are based on the GATT profile 320 and used to send and receive data (or attributes) over a low-energy link. For example, some application profiles 322 that are based on the GATT profile 320 include the Blood Pressure Profile (BLP) to enable a device to connect and interact with a Blood Pressure Sensor device in consumer and professional healthcare applications, the Find Me Profile (FMP) that defines behavior when a button is pressed on one device to cause an alerting signal on a peer device, the Link Loss Service (LLS) to define behavior when a link is lost between devices, and the Proximity Profile (PXP) to enable proximity monitoring between devices, among others.

As indicated above, FIG. 3 is provided as an example. Other examples may differ from what is described with regard to FIG. 3.

FIG. 4 is a diagram illustrating an example 400 of a Bluetooth generic data transport architecture, in accordance with the present disclosure.

In particular, the Bluetooth generic data transport architecture shown in FIG. 4 is divided into various layers, which include a physical layer 410, a logical layer 420, and an L2CAP layer 430. For efficiency and legacy reasons, the Bluetooth generic data transport architecture sub-divides the logical layer 420, distinguishing between logical transports 422 and logical links 424, which provides a general and commonly understood concept whereby a logical link provides an independent transport between two or more devices. The logical transport sub-layer 422 may describe inter-dependences between logical links 424 having different types.

According to various aspects, the lowest layer in the Bluetooth generic data transport architecture is the physical channel 412, wherein all Bluetooth physical channels 412 are characterized according to an RF frequency combined with temporal parameters and restricted according to spatial considerations. For the basic and adapted piconet physical channels 412, frequency hopping is used to change frequency periodically to reduce the effects from interference and to comply with regulatory requirements. In general, two Bluetooth-enabled devices that together implement a particular use case employ a shared physical channel 412 to communicate. Accordingly, the two Bluetooth-enabled devices may need to tune respective transceivers to the same RF frequency at the same time and be within a nominal range from one other. A Bluetooth device is said to be “connected” to a physical channel 412 whenever the Bluetooth device is synchronized to the timing, frequency, and access code associated with the physical channel 412 (whether or not the device is actively involved in communications over the physical channel 412). Although the Bluetooth specification assumes that a device is only capable of connecting to one physical channel 412 at any time, advanced devices may have capabilities to simultaneously connect to more than one physical channel 412.

In BLE implementations, two BLE devices use a shared physical channel 412 to communicate, whereby the two BLE devices may tune respective transceivers to the same physical frequency at the same time and be within a nominal range from one another. However, because physical channels 412 are limited in number and many Bluetooth devices can be operating independently within the same spatial and temporal area, there may be two independent device pairs with transceivers tuned to the same physical channel 412, resulting in a collision. As such, whereas Bluetooth BR/EDR implementations use an access code to identify the piconet, BLE implementations use a randomly generated Access Address to identify a physical link 414. In the event that two devices happen to share the same physical channel 412 in the same area, the targeted device Access Address may be used to determine to which device the communication is directed. Up to the Bluetooth 4.2 specification, there are two physical channels 412 defined for BLE, which include the LE piconet physical channel that connected devices use to communicate over a specific piconet and the LE advertisement broadcast channel that may be used to broadcast advertisements. In general, a BLE device can only use one LE physical channel 412 at any given time, although multiple concurrent operations can be supported using time-division multiplexing between the physical channels 412.

Above the physical channels 412, the physical links 414 represents a baseband connection between Bluetooth-enabled devices. In general, a physical link 414 is associated with one physical channel 412, although a physical channel 412 may support more than one physical link 414, which is a virtual concept that has no direct representation within a transmitted packet structure. The access code packet field, together with the clock and address associated with the master Bluetooth device, are used to identify a physical channel 412. However, the packet does not include a subsequent part that directly identifies the physical link 414. Instead, the physical link 414 may be identified through an association with a logical transport 422, as each logical transport 422 is only received on one physical link 414. In situations where a transmission is broadcast over more than one physical link 414, the transmission parameters are generally selected to be suitable for all physical links 414.

With respect to BLE, the LE piconet physical channels 412 support an LE active physical link 414, which refers to a point-to-point link between a master and a slave that is always present when the slave is in a connection with the master. The physical link 414 between a master and a slave device is active if a default LE asynchronous connectionless (ACL) logical transport exists between the devices, wherein active physical links 414 are identified according to the randomly generated Access Address used in the Link Layer packet. Each Access Address has a one-to-one relationship with the master and the slave of the active physical link 414. The LE advertising physical channels 412 support an LE advertising physical link 414, which refers to a broadcast between the advertiser device and one or more scanner or initiator devices and is always present when the advertiser is broadcasting advertisement events. An advertising physical link 414 between an advertising device and an initiating device for forming a connection (e.g., an active physical link 414) can exist for a relatively short time.

According to various aspects, within the logical layer 420, various logical links 424 are available to support different application data transport requirements. Each logical link 424 is associated with a logical transport 422 that has various characteristics (e.g., flow control, acknowledgement/repeat mechanisms, sequence numbering, scheduling behavior, etc.). In general, logical transports 422 can carry logical links 424 having different types, depending on the type associated with the logical transport 422. In various use cases, logical links 424 can be multiplexed onto the same logical transport 422, which may be carried on active physical links 414 on either a basic or an adapted piconet physical channel 412. Information to identify the logical transport 422 and provide real-time (link control) signaling is carried in a packet header and for certain logical links 424, the identification may be carried in a payload header, while control signaling that does not require single slot response times is carried out using the link manager protocol (LMP). Certain logical transports 422 can support different logical links 424, either concurrently, multiplexed, or one at a time. Within such logical transports 422, the logical link 424 is identified according to one or more logical link identifier (LLID) bits in the payload header associated with baseband packets that carry a data payload. The logical links 424 distinguish between limited core protocols that can transmit and receive data on the logical transports 422. However, some logical transports 422 cannot carry all logical links 424. For example, the SCO and Extended SCO (eSCO) logical transports 422 can only carry constant data rate streams.

According to various aspects, the L2CAP layer 430 provides a multiplexing role allowing different applications to share the resources of a logical link 424 between two devices. Applications and service protocols interface with the L2CAP layer 430 using a channel-oriented interface to create connections to equivalent entities on other devices. In general, L2CAP channel endpoints are identified to their clients according to a CID that L2CAP assigns, wherein each L2CAP channel endpoint on any device has a different CID. At the L2CAP layer 430, L2CAP channels 432 may be configured to provide an appropriate QoS to the application, wherein the L2CAP layer 430 maps the L2CAP channel 432 onto the underlying logical link 424. The L2CAP layer 430 may support channels that are connection-oriented and others that are group-oriented. Apart from creating, configuring, and terminating channels, the L2CAP layer 430 provides a role to multiplex service data units (SDUs) from the channel clients onto the logical links 424 and to carry out scheduling in which SDUs are selected according to relative priority.

According to various aspects, referring again to the logical layer 420 and the physical layer 410, the following table lists various Bluetooth BR/EDR logical transports 422 that are supported up to the Bluetooth 4.2 specification as well as the logical links 424 that such logical transports 422 support, the physical links 414 and the physical channels 412 that can support the logical transports 422, and a brief description associated with each logical transport 422.

TABLE 1
Supported Bluetooth BR/EDR Logical Transports

| Logical | | | |
|---|---|---|---|
| Transport | Logical Link Support | Physical Link Support | Overview |
| Asynchronous | Control (LMP) ACL-C | Active physical link, | Reliable or time- |
| Connection- | User (L2CAP) ACL-U | basic or adapted | bounded, bi- |
| Oriented (ACL) | | physical channel. | directional, point-to- |
| | | | point. |
| Synchronous | Stream (unframed) | Active physical link, | Bi-directional, |
| Connection- | SCO-S | basic or adapted | symmetric, point-to- |
| Oriented | | physical channel. | point, audio/visual |
| (SCO) | | | (AV) channels. Used |
| | | | for 64 Kb/s constant |
| | | | rate data. |
| Extended | Stream (unframed) | Active physical link, | Bi-directional, |
| Synchronous | eSCO-S | basic or adapted | symmetric or |
| Connection- | | physical channel. | asymmetric, point-to- |
| Oriented | | | point, general regular |
| (eSCO) | | | data, limited |
| | | | retransmission. Used |
| | | | for constant rate data |
| | | | synchronized to the |
| | | | master Bluetooth |
| | | | clock. |
| Active slave | User (L2CAP) ASB-U | Active physical link, | Unreliable, uni- |
| broadcast | | basic or adapted | directional broadcast |
| (ASB) | | physical channel. | to any devices |
| | | | synchronized with |
| | | | the physical channel. |
| | | | Used for broadcast |
| | | | L2CAP groups. |
| Parked slave | Control (LMP) PSB- C, | Parked physical link, | Unreliable, uni- |
| broadcast (PSB) | User (L2CAP) PSB-U | basic or adapted | directional broadcast |
| | | physical channel. | to all piconet devices. |
| | | | Used for LMP and |
| | | | L2CAP traffic to |
| | | | parked devices, and |
| | | | for access requests |
| | | | from parked devices. |

According to various aspects, referring again to the logical layer 420 and the physical layer 410, the following table lists various BLE logical transports 422 supported up to the Bluetooth 4.2 specification as well as the logical links 424 that such logical transports 422 support, the physical links 414 and the physical channels 412 that can support the logical transports 422, and a brief description associated with each.

TABLE 2
Supported BLE Logical Transports

| Logical | | | |
|---|---|---|---|
| Transport | Logical Link Support | Physical Link Support | Overview |
| LE | Control (LL) LE-C, | LE Active physical | Reliable or time- |
| Asynchronous | User (L2CAP) LE-U | link, LE piconet | bounded, bi- |
| Connection-Less | | physical channel. | directional, point-to- |
| (LE-ACL) | | | point. |
| LE Advertising | Control (LL) ADVB-C, | LE Advertising | Unreliable due to |
| Broadcast | User (LL) ADVB-U | physical link, LE | lack of |
| (ADVB) | | piconet physical | acknowledgement, |
| | | channel. | packets transmitted a |
| | | | number of times over |
| | | | LE advertising |
| | | | broadcast link to |
| | | | improve reliability |

Notably, the Bluetooth generic data transport architecture that have been defined up to the Bluetooth 4.2 specification do not include any specific support in BLE that can be used to transfer isochronous data (e.g., time-bounded data that has a limited lifetime after which the data becomes invalid). Rather, in the Bluetooth 4.2 specification, Bluetooth BR/EDR implementations can only support time-bounded data through configuring an ACL link to automatically flush packets that have expired. Accordingly, the Bluetooth SIG has proposed features to support isochronous (time-bounded) data, which may refer to information in a stream where each information entity is bound to previous and successive entries according to a time relationship. In general, isochronous data may be used in many applications, including audio as well as time-limited data conveyed in a mesh network (e.g., a television broadcasting audio to one or more users, a music player transmitting personal audio, a public announcement system broadcasting audio within an airport, etc.).

More particularly, according to various aspects, isochronous data support may be enabled in BLE via isochronous physical channels 412 used to transfer isochronous data from a source device to one or more sink devices according to a connection-oriented or connectionless method. For example, in some aspects, the isochronous physical channels 412 may be characterized according to a pseudo-random hopping sequence among a set of PHY data channels (with any packet retransmission(s) done on a different PHY channel), a channel map parameter that indicates the set of PHY channels, a channel selection algorithm used to select the PHY channels, and one or more timing parameters to indicate the first isochronous data packet sent in either a Link Layer connection command or an advertising packet. Furthermore, as noted above, the isochronous physical channels 412 may enable isochronous data to be transferred via a connection-oriented configuration (i.e., a one-to-one configuration in which a source device transfers isochronous data to one sink device) or according to connectionless configuration (i.e., a one-to-many configuration in which the source device broadcasts the isochronous data to one or more sink devices).

More particularly, in some aspects, the isochronous physical channels 412 may support an isochronous physical link 414, which may carry isochronous logical transports 422. For example, as mentioned above, the isochronous logical transport 422 may be connection-oriented, in which case the isochronous physical link 414 may be a point-to-point link between one source device and one sink device. The isochronous physical link 414 used to carry the connection-oriented isochronous logical transport 422 may be identified according to a randomly generated access address used in a Link Layer packet and handle associated with an isochronous connection-oriented (ICO) channel. The ICO channel may therefore provide the isochronous connection-oriented logical transport 422 that can be used to transfer isochronous data between two connected devices (e.g., a phone transferring audio data to and from a wireless headset). After the two devices are connected (i.e., an ACL connection exists), the source device may set up an isochronous logical link 424 with the source device, wherein the isochronous logical link 424 may be defined as an ICO stream that can carry one or more time-related ICO channels. A particular source device may set up ICO streams that each carry one or more time-related ICO channels with one or more source devices in a piconet. An ICO channel may include one or more events that may in turn include one or more sub-events used to transfer packets that include isochronous data between the source device and the sink device(s).

Alternatively and/or additionally, the isochronous logical transport 422 may be an isochronous connectionless (ICL) channel, in which case the isochronous physical link 414 may be a broadcast between a source device and one or more sink devices (e.g., a television broadcasting audio data to one or many users). For example, in some aspects, the source device may set up an ICL stream, which may provide an isochronous logical link 424 that can carry one or more time-related ICL channels. Furthermore, as with an ICO channel, the one or more ICL channels making up an ICL stream may each include one or more events, which may likewise include one or more sub-events used to transfer data packets related to the ICL stream. In some aspects, as will be discussed in further detail below, the source device may broadcast synchronization information associated with the ICL stream in one or more advertising and/or synchronization packets. Accordingly, the isochronous physical link 414 used to carry the isochronous connectionless logical transport 422 may be identified according to an offset associated with the ICL stream, which may be indicated in the one or more advertising and/or synchronization packets. As such, in order to receive the isochronous data broadcasted via one or more ICL channels, a sink device first receives the synchronization information broadcasted via the one or more advertising and/or synchronization packets and then synchronize to the frequency hopping sub-events in the one or more ICL channels. Furthermore, the ICL stream may include an update sub-event that provides a mechanism to allow the source device to provide updated control information to all the sink devices (e.g., a new channel map). As such, the logical transports 422 used to support the ICL logical link 424 may further include an ICL control channel, which may use the isochronous physical link 414 and the update sub-event to broadcast updated control information.

In general, the decision to use an ICO channel or an ICL channel may depend on the use case, which the application profile in the device defines. For example, various reasons to use an ICO channel or an ICL channel are listed in the following table:

TABLE 3
Comparison Between ICO Channels and ICL Channels

| ICO Channels | ICL Channels |
|---|---|
| Point to point (connection based | Point to multipoint |
| use case) | (broadcast use case) |
| Unidirectional or bidirectional | Unidirectional only |
| Retransmission based on | Unconditional retransmission |
| acknowledgment (ACK) / negative | |
| acknowledgement (NACK) | |
| Secure | Encrypted or unencrypted |

Accordingly, isochronous data support may be extended to BLE logical via the isochronous physical channel(s) 412, the isochronous physical link(s) 414, the isochronous logical transport(s) 422, and the isochronous logical link(s) 424 as follows:

TABLE 4
BLE Isochronous Transports

| Logical | | | |
|---|---|---|---|
| Transport | Logical Link(s) Support | Physical Link Support | Overview |
| ICO and ICL | Low Energy-Stream | LE isochronous | Unidirectional or |
| Data Channels | (LE-S) | physical link | bidirectional |
| | | | channels to transfer |
| | | | isochronous data in a |
| | | | point-to-point |
| | | | connection; also |
| | | | supports |
| | | | unidirectional |
| | | | channels to transfer |
| | | | isochronous data in |
| | | | point-to-multipoint |
| | | | connections |
| ICL Control | Low Energy Broadcast | LE isochronous | Unidirectional |
| Channel | Control (LEB-C) | physical link (using | channels to control |
| | | the update sub-event) | broadcasted |
| | | | isochronous data |

As indicated above, FIG. 4 is provided as an example. Other examples may differ from what is described with regard to FIG. 4.

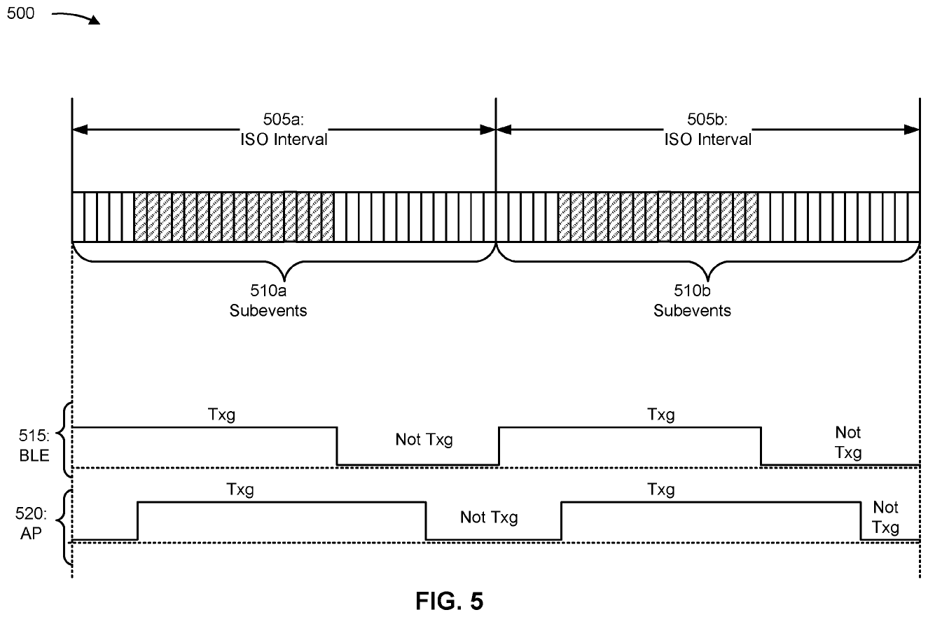

FIG. 5 is a diagram illustrating an example 500 of a short-range wireless communication link, in accordance with the present disclosure.

In some aspects, communication technologies, such as BLE, may communicate via a connected isochronous (ISO) stream (CIS) using multiple ISO intervals, such as the first ISO interval 505a and the second ISO interval 505b. In some aspects, a duration of an ISO interval may be equal to a frame rate of a codec associated with the wireless communication device, which may be 10 milliseconds for BLE. Each ISO interval 505a, 505b may include a number of subevents (NSE), such as the first number of subevents 510a associated with the first ISO interval 505a and the second number of subevents 510b associated with the second ISO interval 505b. Packets (e.g., audio data) may be transmitted using one or more subevents. For example, a transmitting device (sometimes referred to as an Initiator) may transmit a packet containing audio data or the like to a receiving device (sometimes referred to as an Acceptor). When the packet is received, the receiving device may transmit an acknowledgement (ACK) to the transmitting device, and the process may be repeated on a regular basis. If no ACK is received by the transmitting device within a certain time, the transmitting device may assume that the receiving device did not receive the packet, and thus may retransmit the packet using another subevent, sometimes referred to as a retransmission opportunity.

More particularly, when a packet is not received by the receiving device, the transmitting device may retransmit the packet using a subsequent subevent (e.g., retransmission opportunity) within the ISO interval. For example, if only one packet of data is to be transmitted in an ISO interval and is transmitted in the first subevent of the ISO interval 505a or 505b, the transmitting device may have NSE-1 additional opportunities to retransmit the packet of data. Once the packet is received by the receiving device (e.g., once an ACK is received), the transmitting device may cease transmitting for the remainder of the ISO interval 505a or 505b, and the remaining subevents become free airtime for other radio applications, such as applications associated with a WLAN or the like. However, if the packet is not successfully transmitted within the ISO interval 505a or 505b, the packet may be transmitted in a subsequent ISO interval 505a or 505b, if permitted according to a configured flush timeout (FT). For example, if the FT is equal to 1, then the transmitting device will only attempt to transmit a given packet for a single ISO interval 505a or 505b, and, if the transmission fails, the packet is flushed (e.g., dropped). If the FT is equal to 2, the transmitting device will attempt to transmit a given packet for 2 ISO intervals 505a or 505b, if the FT is equal to 3, the transmitting device will attempt to transmit a given packet for 3 ISO intervals 505a or 505b, and so forth.

In some aspects, multiple communication technologies may operate in a similar frequency range (e.g., 2.4 GHz to 2.485 GHz), and thus the communication technologies may compete for airtime during an ISO interval 505a or 505b. In the example depicted in FIG. 5, a wireless communication device may communicate using a first communication technology such as Bluetooth and/or BLE, indicated by reference number 515, during the ISO intervals 505a and 505b, and may communication using a second communication technology such as WLAN (e.g., by receiving communications from an access point (AP)), indicated by reference number 520, also during the ISO intervals 505a and 505b. As shown, the BLE and WLAN may alternate between periods of transmission (shown using “Txg” in FIG. 5) and periods of no transmission or idleness (shown using “No Txg” in FIG. 5), and portions of each technology's transmission times may overlap with one another. That is, the wireless communication device may transmit using BLE during periods of time when an AP is attempting to transmit to the wireless communication device via a WLAN. With regards to the ISO intervals 505a and 505b, this may result in certain subevents in which there are multiple communication technologies competing for the airwaves, as shown using hatching in FIG. 5. As a result, the communication technologies may interfere with one another, resulting in a high transmission failure rate and thus increased retransmissions, leading to latency and reduced throughput, or even flushed packets leading to broken links and otherwise interrupted communications. For example, in some aspects, transmissions originating from an AP may not be received by the wireless communication device due to the wireless communication device actively transmitting using the BLE technology, requiring multiple retransmissions by the AP and, after a certain time-out period or the like, dropped packets by the AP. In some other aspects, additional communication technologies (e.g., a third communication technology, a fourth communication technology, and so forth) may compete for airtime during the ISO intervals 505a, 505b, such as in aspects employing concurrent/multipoint communications, causing further interference, latency, reduced throughput, flushed packets, broken links, and/or otherwise interrupted communications.

Some techniques and apparatuses described herein enable a configuration of a short-range wireless communication link that reduces interference among competing short-range communication technologies, thereby resulting in more robust communication links and thus more reliable communications. In some aspects, a wireless communication device may configure a short-range wireless communication link for use by a first communication technology. For example, the wireless communication device may configure an ISO interval for use by Bluetooth and/or BLE, or the like. A configuration of the short-range wireless communication link may maximize retransmission opportunities within the wireless communication link in order to support multiple coexistence transmission patterns associated with the first communication technology and a second communication technology (e.g., a communication technology associated with a WLAN, or the like). In some aspects, the wireless communication device may transmit, to another wireless communication device, a communication using at least one of the first communication technology and the second communication technology based at least in part on a selected coexistence transmission pattern. By maximizing the retransmission opportunities within the configured wireless communication link and selecting an appropriate coexistence transmission pattern, the wireless communication device may beneficially schedule the competing communication technologies in a way that reduces interference among the communications, resulting in decreased retransmissions, decreased latency, increased throughput, and overall more efficient and reliable short-range wireless communications.

As indicated above, FIG. 5 is provided as an example. Other examples may differ from what is described with regard to FIG. 5.

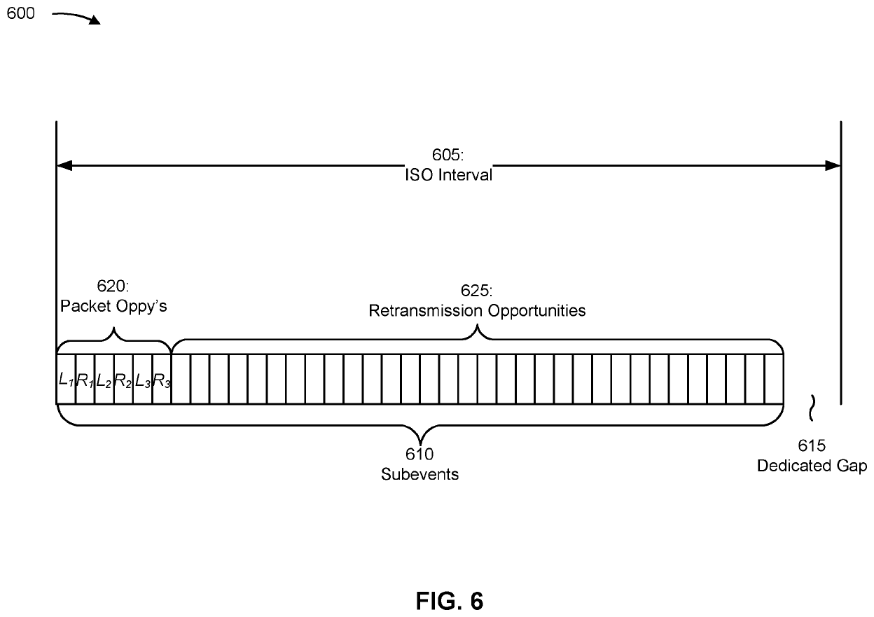

FIG. 6 is a diagram illustrating an example 600 of a short-range wireless communication link, in accordance with the present disclosure.

The example shown in FIG. 6 includes an ISO interval 605 including a number of subevents 610. In some aspects, the ISO interval 605 may also include a dedicated gap 615, which may be used for purposes of a buddy link, or the like. A wireless communication device may configure the ISO interval 605 such that a number of retransmit opportunities associated with a first communication technology (e.g., Bluetooth and/or BLE) are maximized. More particularly, the ISO interval 605 may be configured to include one or more packet opportunities 620, which may be used to transmit packets of audio data or the like, and multiple retransmission opportunities 625. A duration of the multiple retransmission opportunities 625 may be larger than a duration of the packet opportunities 620 in order to maximize instances for retransmitting any data packets that failed to reach a receiver (e.g., retransmit packets for which no ACK was received) and/or for use by other short-range communication technologies. In some aspects, the link configuration shown in FIG. 6 may be used for multiple Bluetooth codec rates.

More particularly, in some aspects, audio data or the like may be transmitted by a Bluetooth transmitter associated with a wireless communication device in a set of data of data packets. In the example shown in FIG. 6, the set of data packets includes left and right packets for ease of discussion, but aspects of the disclosure are not so limited. In some other aspects, the set of data packets may include one or more data channels (e.g., up to N data channels). In some aspects, Nmay be equal to two when audio data is transmitted in left and right packets and/or channels, and Nmay be greater than two when audio data is transmitted using more packets and/or channels (e.g., the set of packets may include packets and/or channels corresponding to left (L), right (R), center (C), surround left (SL), surround right (SR), low frequency effects (LFE), or similar channels). In some aspects, when a receiving device (e.g., an Acceptor) is a pair of earbuds, a pair of stereo speakers, or the like, a first audio packet may be transmitted to a left earbud, left speaker, or the like, and a second audio packet may be transmitted to a right earbud, right speaker, or the like. In this regard, packets may be transmitted in pairs of packets including a left audio packet and a right audio packet, which each packet transmitted in a corresponding subevent. The ISO interval 605 may be configured to include a relatively small number of packet opportunities 620 as compared to a number of retransmission opportunities 625, such as, in the depicted example, six subevents, which may thus be used to transmit three pairs of left/right audio packets. In FIG. 6, the first pair of left-right audio packets is shown using L₁ and R₁, the second pair of left-right audio packets is shown using L₂ and R₂, and the third pair of left-right audio packets is shown using L₃ and R₃.

Because the retransmission opportunities 625 have been maximized in this configuration, the wireless communication device (e.g., a coexistence component associated with the wireless communication device) with may stomp certain of the retransmission opportunities 625 for use by other short-range communications technologies (e.g., WLAN). More particularly, the wireless communication device may dedicate a certain number of the retransmission opportunities 625 to be used for retransmission of the Bluetooth packets (e.g., L₁, R₁, L₂, R₂, L₃, or R₃) but may otherwise stomp out remaining retransmission opportunities 625 (e.g., block off from use by the Bluetooth transmitter, and instead dedicate them for use by another communication technology such as WLAN). In some aspects, the coexistence component may select a coexistence transmission pattern (e.g., a stomping pattern) from multiple coexistence transmission patterns to dedicate certain subevents 610 to each of multiple communication technologies (e.g., Bluetooth and/or BLE, WLAN, or the like).

Although for ease of discussion the following coexistence transmission patterns are described in connection with two communication technologies (e.g., a first communication technology, such as BLE, and a second communication technology, such as WLAN), aspects of the disclosure are not so limited. In some aspects, the coexistence transmission patterns may be utilized to support coexistence of three or more communication technologies, such as to allow time for concurrent/multipoint communications. In such aspects, a third group of subevents may be dedicated to concurrent/multipoint connections, which, in some aspects, may be scheduled by a wireless communication device on either end of a main connection. In such aspects, the concurrent/multipoint connections may be Bluetooth and/or BLE, may be WLAN, or may be another communication technology (e.g., the third communication technology may be associated with the same communication technology as one of the first communication technology or the second communication technology, or the third communication technology may be a different communication technology than the first communication technology and the second communication technology).

In some aspects, the coexistence transmission pattern may be dynamically selected based at least in part on a link quality associated with one of the communication technologies (e.g., a Bluetooth link quality, or the like). For example, a Bluetooth transmitter may provide link quality information to a coexistence component, which may allocate more or less subevents 610 for purposes of retransmission of audio data packets or the like based at least in part on the link quality information. For example, a poor link quality may result in more subevents 610 being allocated for Bluetooth transmission in order to provide for more retransmissions, while a strong link quality may result in less subevents 610 being allocated for Bluetooth transmission because numerous retransmissions may not be necessary. Additionally, or alternatively, the coexistence transmission pattern may be dynamically selected based at least in part on a demand for one or more of the communication technologies. For example, traffic shaping may change dynamically depending on the demand of each technology with more subevents and/or ISO intervals being dedicated to a high-demand technology and less subevents and/or ISO intervals being dedicated to a low-demand technology. In some aspects, the coexistence transmission pattern may be dynamically selected based at least in part on a policy of maximizing performance of each technology when demand allows.

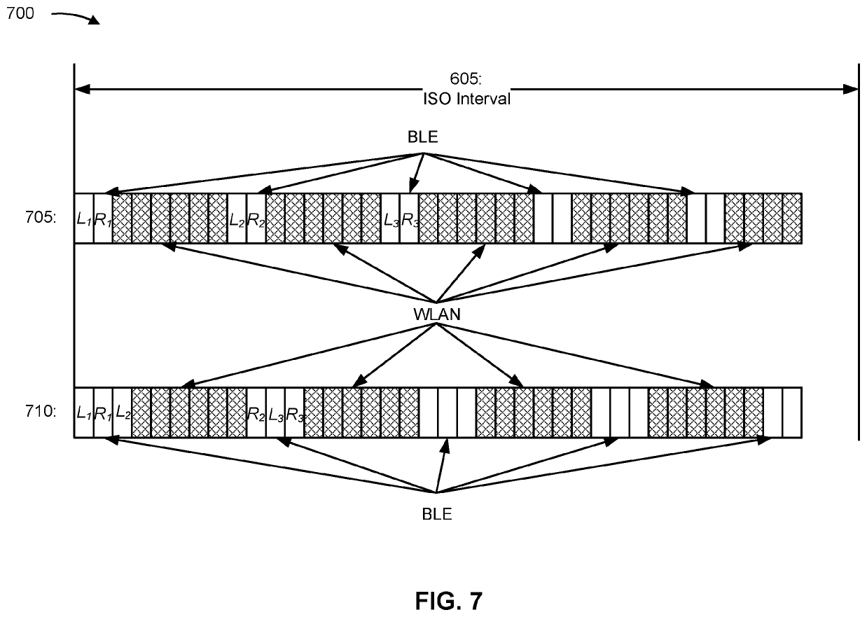

Various coexistence transmission patterns enabled by the link configuration shown in FIG. 6 are described in more detail in connection with FIGS. 7-9.

As indicated above, FIG. 6 is provided as an example. Other examples may differ from what is described with regard to FIG. 6.

FIG. 7 is a diagram illustrating an example 700 of a short-range wireless communication link, in accordance with the present disclosure.

More particularly, FIG. 7 shows the ISO interval 605 described above implemented with a coexistence transmission pattern that intersperses groups of subevents dedicated for use by a first communication technology (e.g., Bluetooth and/or BLE) among groups of subevents dedicated for use by another communication technology (e.g., WLAN), such that the wireless communication device distributes Bluetooth packets or the like across the ISO interval 605, or, in some aspects, across multiple ISO intervals 605. Put another way, the coexistence transmission pattern includes multiple groups of one or more subevents dedicated for use by the first communication technology (e.g., Bluetooth and/or BLE, which are shown without shading in FIG. 7) and multiple groups of one or more subevents dedicated for use by the second communication technology (e.g., WLAN, which are shown using cross-hatching in FIG. 7), and the multiple groups of one or more subevents dedicated for use by the first communication technology are distributed across the ISO interval 605 such that a group of one or more subevents dedicated for use by the second communication technology is interspersed between each group of the multiple groups of one or more subevents dedicated for use by the first communication technology. The wireless communication device (e.g., a coexistence component of the wireless communication device) may accomplish the coexistence transmission patterns shown in FIG. 7 by stomping out Bluetooth transmissions (e.g., turning off a Bluetooth transmitter and/or otherwise preventing a Bluetooth transmission) during the periods of time in which the subevents are shown with cross-hatching. For example, in the ISO interval 605 shown at reference number 705, after a first set of packets (e.g., the first two packets (e.g., L₁ and R₁) in the depicted example, but which may include more or less packets and/or channels in other aspects) are transmitted by the wireless communication device, the coexistence component may stomp out transmissions of the remaining packets (e.g., L₂, R₂, L₃, and R₃) to permit other communication technologies (e.g., WLAN, BLE in the case of concurrent/multipoint connections, and/or a similar communication technology) to use the airwaves. The wireless communication device may then use groups of subevents that occur within the retransmission opportunities (e.g., a first group shown with L₂ and R₂ in FIG. 7, and a second group shown with L₃ and R₃ in FIG. 7), to transmit (e.g., retransmit) the remaining data packets. The coexistence transmission pattern shown by reference number 710 operates in a similar manner, but with three subevents occurring in each of the groups of subevents dedicated for use by the Bluetooth transmitter. In some other aspects, more or less subevents may be included in each of the groups of subevents dedicated for use by the Bluetooth transmitter.

In some aspects, the groups of subevents may be configured and/or selected such that a set of audio packets (e.g., N audio packets, such as a left audio packet and a right audio packet in the depicted example), are distributed together, as shown in the ISO interval 605 indicated by reference number 705. However, this need not be the case, and, in some other aspects, the groups of subevents may be configured and/or selected such that a set of audio packets (e.g., a left audio and a right audio packet) are not distributed together (e.g., such that a left audio packet (e.g., L₂) is transmitted using a first group of the multiple groups of one or more subevents dedicated for use by the first communication technology, and such the right audio packet (e.g., R₂) is transmitted using a second group of the multiple groups of one or more subevents dedicated for use by the first communication technology), as shown in the ISO interval 605 indicated by reference number 710.

Beneficially, in such aspects a duration of each of the groups of subevents dedicated for use by the first communication technology may be limited (e.g., in the depicted aspects two or three subevents long) to prevent adverse effects to other communication technologies such as WLAN or the like. More particularly, a duration of each group of the multiple groups of one or more subevents dedicated for use by the first communication technology may be less than a duration threshold. For example, when Bluetooth communications and WLAN communications overlap for extended periods of time, such as in the case shown in FIG. 5, the WLAN communications may not reach an intended receiver due to the interference from the Bluetooth communications, as described. In such aspects, a WLAN transmitter (which, in some aspects, may be an AP transmitting to the wireless communication device) may attempt to retransmit packets during the period of overlap (e.g., during the subevents shown with hatching in FIG. 5), multiple times, and, in some aspects, may time-out or otherwise drop the packets if the transmission continues to be unsuccessful. Additionally, or alternatively, due to the repeated transmission failures, the AP may determine that the WLAN link is poor, and thus adjust transmission parameters according, such as reducing data rates or the like.

In the aspects depicted in FIG. 7, however, the Bluetooth groups of subevents are relatively short in duration, and thus if an AP or the like attempts to transmit packets during the Bluetooth groups and is unsuccessful, the AP may be able to successfully retransmit the packets in a group of subevents dedicated for use by the WLAN, which may only be one or two subevents away. Thus, the AP is not likely to time-out or otherwise flush or drop packets, and/or the AP may not determine that the communication link is poor, thus avoiding adverse adjustments to transmission parameters or the like.

As indicated above, FIG. 7 is provided as an example. Other examples may differ from what is described with regard to FIG. 7.

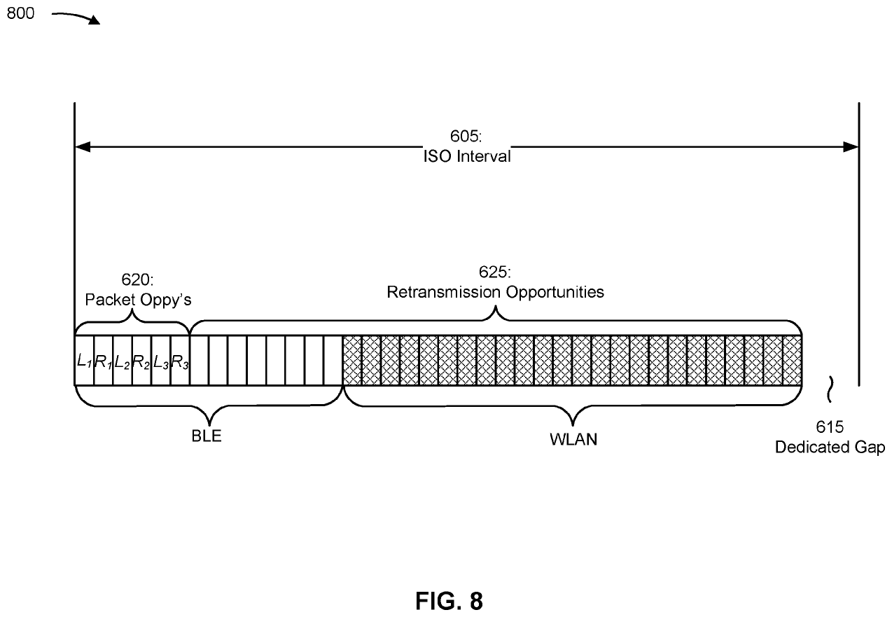

FIG. 8 is a diagram illustrating an example 800 of a short-range wireless communication link, in accordance with the present disclosure.

More particularly, FIG. 8 shows the ISO interval 605 described above implemented with a coexistence transmission pattern that aggregates transmission time for use by a first communication technology (e.g., Bluetooth and/or BLE) into a first part of the ISO interval 605, and that aggregates transmission time for use by another communication technology (e.g., WLAN) into a second part of the ISO interval 605 (e.g., during a configured retransmission opportunities 625 of the ISO interval 605). Again, in some aspects, three or more communication technologies may be implemented (e.g., in concurrent/multipoint connections), in which case a transmission time for a third communication technology may be aggregated into a third part of the ISO interval 605, a transmission time for a fourth communication technology may be aggregated into a fourth part of the ISO interval 605, and so forth. Put another way, in this aspect the coexistence transmission pattern includes a first group of subevents dedicated for use by the first communication technology (e.g., Bluetooth and/or BLE, which is shown without shading in FIG. 7) and a second group of subevents dedicated for use by the second communication technology (e.g., WLAN, which is shown using cross-hatching in FIG. 7), and the first group of subevents may occur at a beginning portion of the ISO interval 605 while the second group of subevents may occur at an ending portion of the ISO interval 605. The wireless communication device (e.g., a coexistence component of the wireless communication device) may accomplish the coexistence transmission patterns shown in FIG. 8 by stomping out Bluetooth transmissions (e.g., turning off a Bluetooth transmitter and/or otherwise preventing a Bluetooth transmission) during the periods of time in which the subevents are shown with cross-hatching. For example, after the six packets (e.g., L₁, R₁, L₂, R₂, L₃, and R₃) are transmitted by the wireless communication device using the subevents associated with the packet opportunities 620, and following a number of subevents associated with retransmission opportunities 625 that may be dedicated for retransmission of any of the packets for which an ACK was not received, the wireless communication device may stomp out Bluetooth transmissions to permit other communication technologies (e.g., WLAN) to use the airwaves.

Moreover, the wireless communication device may stomp out more or less subevents in each subsequent ISO interval 605 based at least in part on link quality feedback from the Bluetooth transmitter or the like. For example, for a deteriorating Bluetooth link, the coexistence component may shrink the WLAN portion of the ISO interval 605 (e.g., dedicate fewer subevents for WLAN communications) in order to provide more retransmission opportunities for the Bluetooth transmitter. Similarly, for an improving Bluetooth link where many retransmissions are not necessary, the coexistence component may increase the WLAN portion of the ISO interval 605 (e.g., dedicate more subevents for WLAN communications). Put another way, the second group of subevents dedicated for use by the second communication technology may be associated with a first number of subevents in a first ISO interval 605, and may be associated with a second number of subevents, different than the first number of subevents, in a second ISO interval 605 (e.g., in some aspects, the second number of subevents may be less than the first number of subevents), and/or the wireless communication device (e.g., a coexistence component of the wireless communication device) may reduce the first number of subevents to the second number of subevents based at least in part on detecting a link quality associated with the first communication technology.

Beneficially, in such aspects, one or more transmitters and/or receivers associated with various communication technologies may go into a power-saving mode, a reduced-activity mode, or similar mode during groups of subevents dedicated to other communication technologies. That is, in some aspects, the first communication technology may be associated with a power-saving mode during the second group of subevents, or the second communication technology may be associated with a power-saving mode during the first group of subevents. For example, a WLAN component of a wireless communication device may go into a power-saving mode during the first group of subevents (e.g., the unshaded subevents in FIG. 8), and a Bluetooth component of a wireless communication device may go into a power-saving mode during the second group of subevents (e.g., the subevents shown with cross-hatching in FIG. 8). More particularly, after transmitting or receiving data during the second group of subevents, a WLAN component may transmit an indication to an AP or the like indicating that it will be in a power-saving mode during the first group of subevents in the next ISO interval 605, and thus the AP should not attempt to transmit communications to the wireless communication device during the first group of subevents. Thus, the Bluetooth transmitter and an AP, or the like, may beneficially be allocated dedicated time to use the airwaves, thus reducing interference and improving channel quality.

As indicated above, FIG. 8 is provided as an example. Other examples may differ from what is described with regard to FIG. 8.

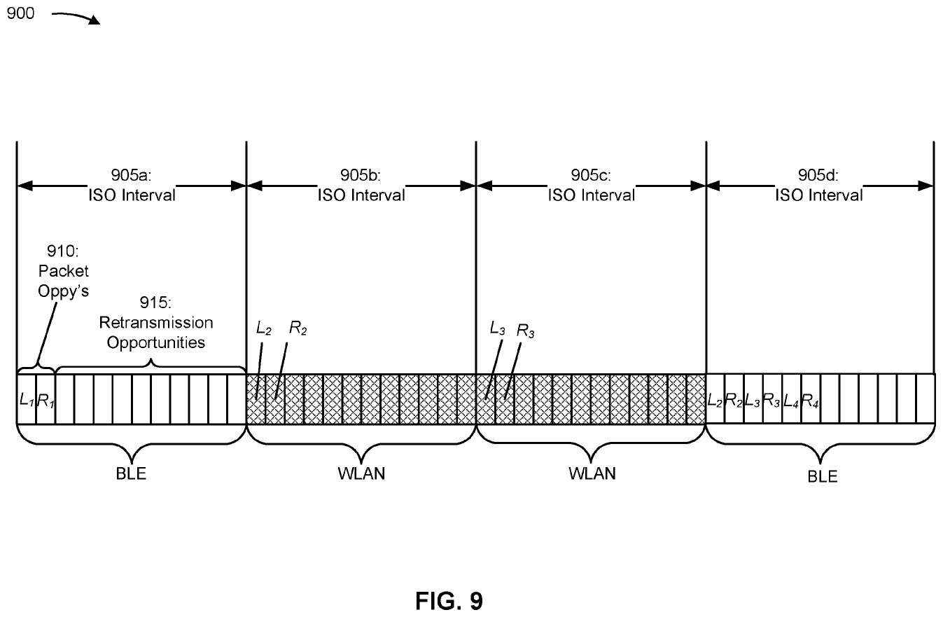

FIG. 9 is a diagram illustrating an example 900 of a short-range wireless communication link, in accordance with the present disclosure.

In some aspects, the short-range wireless communication link (e.g., ISO interval) may be configured to be relatively short, in the time duration, but may be configured with multiple FTs to improve transmission reliability, accordingly (e.g., the wireless communication device may select an FT associated with the ISO interval based at least in part on the number of subevents of the ISO interval). For example, in FIG. 9 the depicted ISO intervals 905a, 905b, 905c, and 905d, are configured to be shorter, in the time duration, that the ISO interval 605 described in connection with FIGS. 6-8. In some aspects, the ISO intervals 905a, 905b, 905c, and 905d may be 1/K of the length of the ISO interval 605, may include at least K times the FTs accordingly (e.g., the ISO intervals 905a, 905b, 905c, and 905d may be ⅓ of the length of the ISO interval 605, but may include a configured FT of 3 instead of 1). In that regard, each ISO interval 905a, 905b, 905c, and 905d may include less packet opportunities 910 and less retransmission opportunities 915 than the packet opportunities 620 and the retransmission opportunities 625, respectively, of the ISO interval 605. For example, the ISO intervals 905a, 905b, 905c, and 905d may each include two subevents configured as packet opportunities 910, with the remaining subevents of the ISO intervals 905a, 905b, 905c, and 905d configured as retransmission opportunities 915.

In such aspects, the wireless communication device may stomp out entire ISO intervals 905a, 905b, 905c, and 905d for use for other communication technologies such as WLAN, BLE in concurrent/multipoint connections, or the like. For example, as shown using no shading in FIG. 9, a first ISO interval 905a and a fourth ISO interval 905b may be used by the first communication technology (e.g., Bluetooth and/or BLE), and a second ISO interval 905b and a third ISO interval 905c may stomped out to provide a time duration for transmission by the second communication technology (e.g., WLAN). Moreover, because, in this example, there may be less packet opportunities than in the examples described above, the packets may need to be transmitted by the first communication technology over several ISO intervals 905a, 905b, 905c, and 905d. For example, the first and second packets (e.g., L₁ and R₁) may be transmitted in the first ISO interval 905a (and may be retransmitted using the retransmission opportunities of the first ISO interval 905a, if either is not successfully received). Moreover, the third and fourth packets (e.g., L₂ and R₂) and the fifth and sixth packets (e.g., L₃ and R₃) may be scheduled for transmission in in the second ISO interval 905b and the third ISO interval 905c, respectively, but may be stomped out by the wireless communication device (e.g., a coexistence component of the wireless communication device). Thus, assuming the FT is configured to be greater than 1 so that the Bluetooth transmitter does not flush the packets after a first unsuccessful transmission in an ISO interval, the packets may be retransmitted in subsequent ISO intervals, such as in the fourth ISO interval 905b, as shown. In a similar manner as described above, one or more of the communication technologies may enter a power-saving mode or other reduced-activity mode during subevents dedicated for use by another communication technology.

In some aspects, a coexistence component and/or a coexistence transmission pattern may be limited to a maximum NSE size, such as an NSE of 31. Beneficially, by configuring the ISO interval 905a, 905b, 905c, or 905d to be less than or equal to the maximum NSE associated with coexistence component and/or a coexistence transmission pattern (e.g., NSE=31), subevents may be dedicated to one or more communication technologies, reducing interference. Put another way, in some aspects, the selected coexistence transmission pattern is associated with a maximum NSE, and a NSE of the ISO interval 905a, 905b, 905c, 905d may be smaller than the maximum NSE associated with the coexistence transmission pattern, such that one or more of the coexistence transmission patterns described herein may be implemented.

As indicated above, FIG. 9 is provided as an example. Other examples may differ from what is described with regard to FIG. 9.

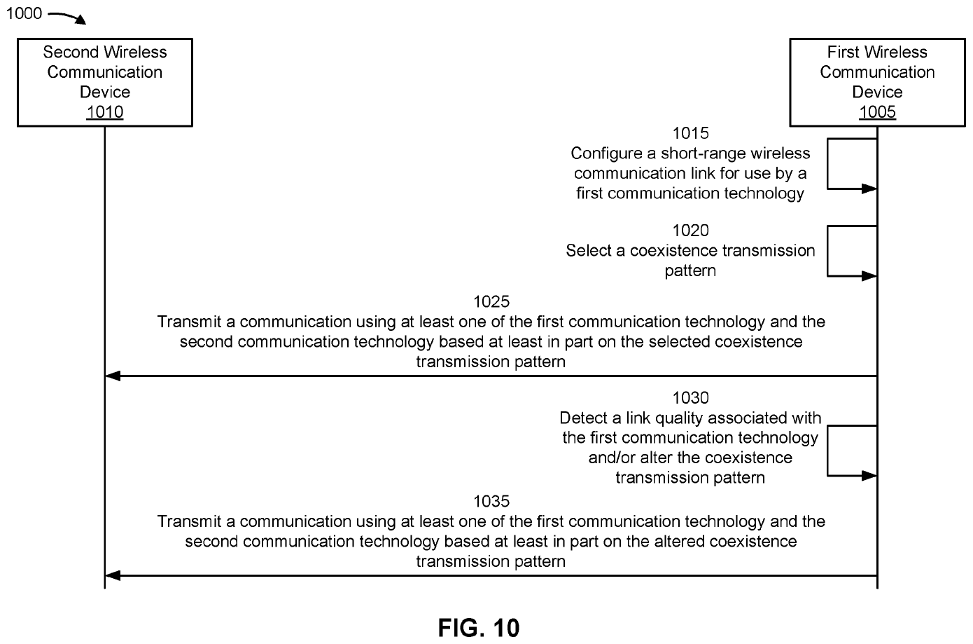

FIG. 10 is a diagram illustrating an example 1000 associated with BLE coexistence link configuration, in accordance with the present disclosure. As shown in FIG. 10, a first wireless communication device 1005 and a second wireless communication device 1010 may communicate with one another. In some aspects, the first wireless communication device 1005 may be a UE or similar device capable of communicating using various communication technologies, including a first communication technology such as BLE, a second communication technology such as WLAN, or other communication technologies such as a communication technology associated with a radio access network (e.g., 5G or NR, or the like). The second wireless communication device 1010 may be a device capable of communicating using at least one communication technology, such as BLE.

As shown by reference number 1015, the first wireless communication device 1005 may configure a short-range wireless communication link for use by a first communication technology. In some aspects, a configuration of the short-range wireless communication link may include a number of configured retransmission opportunities to support multiple coexistence transmission patterns associated with the first communication technology and a second communication technology. For example, in some aspects, the short-range wireless communication link may be associated with an ISO interval comprising multiple subevents, such as the ISO interval 605 described in connection with FIG. 6, or an ISO interval 905a, 905b, 905c, or 905d described in connection with FIG. 9. Moreover, in some aspects, one of the first communication technology and the second communication technology may associated with BLE, and/or one of the first communication technology and the second communication technology may associated with a WLAN, as described.

As shown by reference number 1020, in some aspects, the first wireless communication device 1005 may select the selected coexistence transmission pattern, of the multiple coexistence transmission patterns. For example, in some aspects the first wireless communication device may select one of the coexistence transmission patterns described in connection with FIGS. 7-9, and thus stomp out certain subevents associated with the short-range wireless communication link for use by the first communication technology, accordingly.

As shown by reference number 1025, the first wireless communication device 1005 may transmit, to the second wireless communication device 1010, a communication using at least one of the first communication technology and the second communication technology based at least in part on a selected coexistence transmission pattern, of the multiple coexistence transmission patterns. For example, the first wireless communication device 1005 may transmit a communication using BLE during certain subevents, while not transmitting using BLE during other subevents in order to clear the channels for other short-range wireless communication (e.g., WLAN), as described.

As shown by reference number 1030, the first wireless communication device 1005 may detect a link quality associated with the first communication technology and may alter the coexistence transmission pattern, accordingly. For example, in response to detecting a deteriorating or improving Bluetooth link, the first wireless communication device 1005 may switch between coexistence transmission patterns and/or alter groups of subevents dedicated to each communication technology in order to provide more or less subevents dedicated for use by the Bluetooth transmitter. Beneficially, because the short-range communication link may be configured to include a number of configured retransmission opportunities to support multiple coexistence transmission patterns, as described, the wireless communication device may easily and dynamically switch between selected coexistence transmission patterns and/or alter a number of subevents dedicated to each technology, as described.

In such aspects, and as shown by reference number 1035, the first wireless communication device 1005 may transmit, to the second wireless communication device 1010, a communication using at least one of the first communication technology and the second communication technology based at least in part on an altered coexistence transmission pattern. In this way, the first wireless communication device 1005 may dynamically allocate more or less groups of subevents and/or more or less subevents to the various communication technologies, as described.

As indicated above, FIG. 10 is provided as an example. Other examples may differ from what is described with respect to FIG. 10.

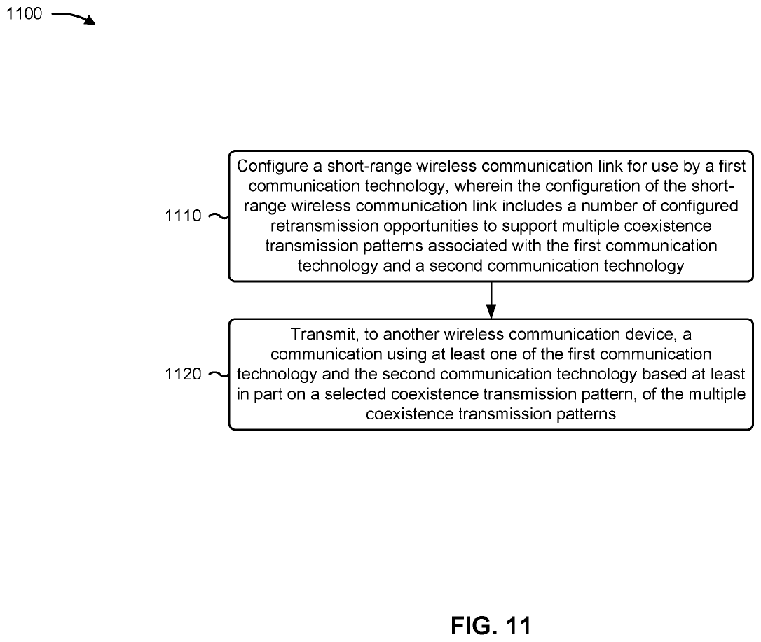

FIG. 11 is a diagram illustrating an example process 1100 performed, for example, by a wireless communication device, in accordance with the present disclosure. Example process 1100 is an example where the wireless communication device (e.g., first wireless communication device 1005) performs operations associated with BLE coexistence link configuration.

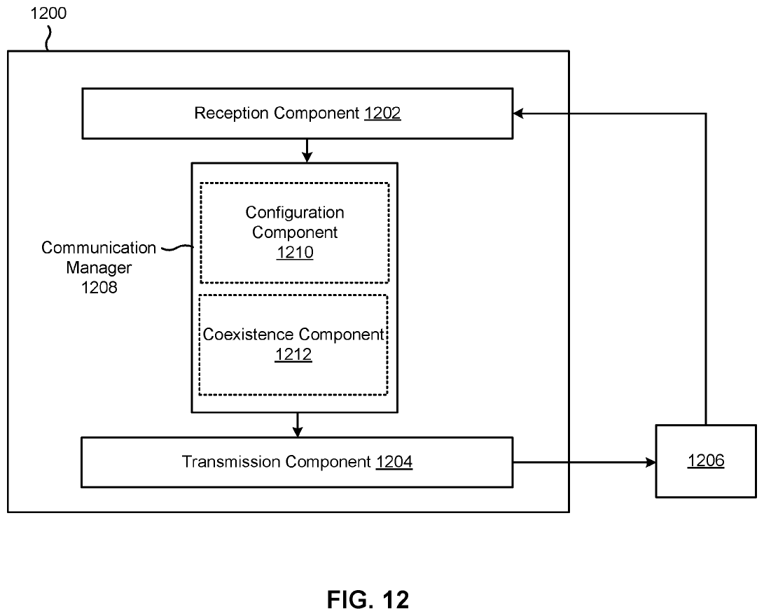

As shown in FIG. 11, in some aspects, process 1100 may include configuring a short-range wireless communication link for use by a first communication technology, wherein a configuration of the short-range wireless communication link includes a number of configured retransmission opportunities to support multiple coexistence transmission patterns associated with the first communication technology and a second communication technology (block 1110). For example, the wireless communication device (e.g., using communication manager 1208 and/or configuration component 1210, depicted in FIG. 12) may configure a short-range wireless communication link for use by a first communication technology, wherein a configuration of the short-range wireless communication link includes a number of configured retransmission opportunities to support multiple coexistence transmission patterns associated with the first communication technology and a second communication technology, as described above.

As further shown in FIG. 11, in some aspects, process 1100 may include transmitting, to another wireless communication device, a communication using at least one of the first communication technology and the second communication technology based at least in part on a selected coexistence transmission pattern, of the multiple coexistence transmission patterns (block 1120). For example, the wireless communication device (e.g., using communication manager 1208, transmission component 1204, and/or coexistence component 1212, depicted in FIG. 12) may transmit, to another wireless communication device, a communication using at least one of the first communication technology and the second communication technology based at least in part on a selected coexistence transmission pattern, of the multiple coexistence transmission patterns, as described above.

Process 1100 may include additional aspects, such as any single aspect or any combination of aspects described below and/or in connection with one or more other processes described elsewhere herein.

In a first aspect, one of the first communication technology and the second communication technology is associated with BLE.

In a second aspect, alone or in combination with the first aspect, one of the first communication technology and the second communication technology is associated with a WLAN.

In a third aspect, alone or in combination with one or more of the first and second aspects, process 1100 includes selecting the selected coexistence transmission pattern, of the multiple coexistence transmission patterns.

In a fourth aspect, alone or in combination with one or more of the first through third aspects, the short-range wireless communication link is associated with an ISO interval comprising multiple subevents.

In a fifth aspect, alone or in combination with one or more of the first through fourth aspects, the selected coexistence transmission pattern includes multiple groups of one or more subevents dedicated for use by the first communication technology and multiple groups of one or more subevents dedicated for use by the second communication technology.

In a sixth aspect, alone or in combination with one or more of the first through fifth aspects, the multiple groups of one or more subevents dedicated for use by the first communication technology are distributed across the ISO interval such that a group of one or more subevents dedicated for use by the second communication technology is interspersed between each group of the multiple groups of one or more subevents dedicated for use by the first communication technology.

In a seventh aspect, alone or in combination with one or more of the first through sixth aspects, transmitting the communication using at least one of the first communication technology and the second communication technology based at least in part on the selected coexistence transmission pattern includes transmitting a set of data packets.

In an eighth aspect, alone or in combination with one or more of the first through seventh aspects, a first data packet, of the set of data packets, is transmitted using a first group of the multiple groups of one or more subevents dedicated for use by the first communication technology, and a second data packet, of the set of data packets, is transmitted using a second group of the multiple groups of one or more subevents dedicated for use by the first communication technology.

In a ninth aspect, alone or in combination with one or more of the first through eighth aspects, a duration of each group of the multiple groups of one or more subevents dedicated for use by the first communication technology is less than a duration threshold.

In a tenth aspect, alone or in combination with one or more of the first through ninth aspects, the selected coexistence transmission pattern includes a first group of one or more subevents dedicated for use by the first communication technology and a second group of one or more subevents dedicated for use by the second communication technology.

In an eleventh aspect, alone or in combination with one or more of the first through tenth aspects, a duration of the second group of one or more subevents dedicated for use by the second communication technology is greater than a duration threshold.

In a twelfth aspect, alone or in combination with one or more of the first through eleventh aspects, the first group of one or more subevents occurs at a beginning portion of the ISO interval and the second group of one or more subevents occurs at an ending portion of the ISO interval.

In a thirteenth aspect, alone or in combination with one or more of the first through twelfth aspects, each subevent of the second group of one or more subevents occurs during a configured retransmission opportunity.

In a fourteenth aspect, alone or in combination with one or more of the first through thirteenth aspects, the second group of one or more subevents is associated with a first number of subevents in a first ISO interval, and the second group of one or more subevents is associated with a second number of subevents, different than the first number of subevents, in a second ISO interval.

In a fifteenth aspect, alone or in combination with one or more of the first through fourteenth aspects, the second number of subevents is less than the first number of subevents.

In a sixteenth aspect, alone or in combination with one or more of the first through fifteenth aspects, process 1100 includes reducing the first number of subevents to the second number of subevents based at least in part on detecting a link quality associated with the first communication technology.

In a seventeenth aspect, alone or in combination with one or more of the first through sixteenth aspects, process 1100 includes changing the first number of subevents to the second number of subevents based at least in part on a demand for at least one of the first communication technology or the second communication technology.

In an eighteenth aspect, alone or in combination with one or more of the first through seventeenth aspects, at least one of the first communication technology is associated with a power-saving mode during the second group of one or more subevents, or the second communication technology is associated with a power-saving mode during the first group of one or more subevents.

In a nineteenth aspect, alone or in combination with one or more of the first through eighteenth aspects, the selected coexistence transmission pattern is associated with a maximum number of subevents, and a number of subevents of the ISO interval is smaller than the maximum number of subevents associated with the coexistence transmission pattern.

In a twentieth aspect, alone or in combination with one or more of the first through nineteenth aspects, process 1100 includes selecting a flush timeout associated with the ISO interval based at least in part on the number of subevents associated with one of the ISO interval or the coexistence transmission pattern.

In a twenty-first aspect, alone or in combination with one or more of the first through twentieth aspects, the selected coexistence transmission pattern includes at least a portion of a first ISO interval dedicated for use by the first communication technology and at least a portion of a second ISO interval dedicated for use by the second communication technology.

In a twenty-second aspect, or in combination with one or more of the first through twenty-first aspects, the selected coexistence transmission pattern includes multiple isochronous intervals dedicated for use by one of the first communication technology or the second communication technology.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a wireless communication device (e.g., first wireless communication device 1005), or a wireless communication device may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may include one or more of a configuration component 1210, or a coexistence component 1212, among other examples.

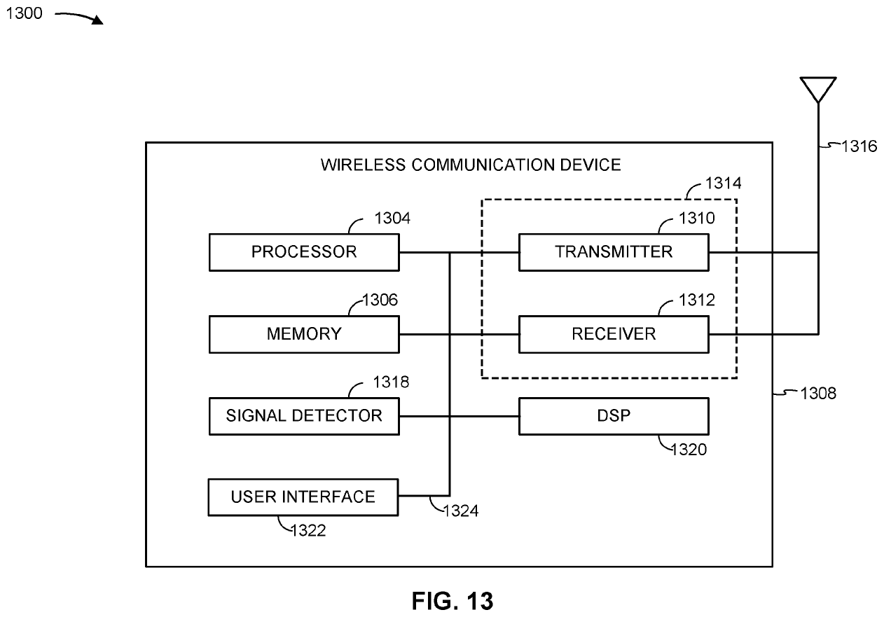

In some aspects, the apparatus 1200 may be configured to perform one or more operations described herein in connection with FIGS. 6-10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the wireless communication device described below in connection with FIG. 13. Additionally, or alternatively, one or more components shown in FIG. 12 may be implemented within one or more components described in connection with FIG. 13. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a multiple input multiple output (MIMO) detector, a receive processor, a controller/processor, a memory, or a combination thereof, of the wireless communication device described in connection with FIG. 13.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the wireless communication device described in connection with FIG. 13. In some aspects, the transmission component 1204 may be co-located with the reception component 1202 in a transceiver.

The configuration component 1210 may configure a short-range wireless communication link for use by a first communication technology, wherein a configuration of the short-range wireless communication link includes a number of configured retransmission opportunities to support multiple coexistence transmission patterns associated with the first communication technology and a second communication technology. The transmission component 1204 may transmit, to another wireless communication device, a communication using at least one of the first communication technology and the second communication technology based at least in part on a selected coexistence transmission pattern, of the multiple coexistence transmission patterns.

The coexistence component 1212 may select the selected coexistence transmission pattern, of the multiple coexistence transmission patterns.

The coexistence component 1212 may reduce the first number of subevents to the second number of subevents based at least in part on detecting a link quality associated with the first communication technology.

The coexistence component 1212 may change the first number of subevents to the second number of subevents based at least in part on a demand for at least one of the first communication technology or the second communication technology.

The configuration component 1210 may select a flush timeout associated with the ISO interval based at least in part on the number of subevents associated with one of the ISO interval or the coexistence transmission pattern.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram illustrating an example 1300 of a wireless communication device, according to aspects of the disclosure.

The wireless communication device shown in FIG. 13 may correspond to a wireless communication device that can configure a short-range wireless communication link for use by a first communication technology, with a configuration of the short-range wireless communication link including a number of configured retransmission opportunities to support multiple coexistence transmission patterns associated with the first communication technology and a second communication technology, and transmit, to another wireless communication device, a communication using at least one of the first communication technology and the second communication technology based at least in part on a selected coexistence transmission pattern, of the multiple coexistence transmission patterns. In some aspects, the wireless communication device may include a processor 1304, a memory 1306, a housing 1308, a transmitter 1310, a receiver 1312, an antenna 1316, a signal detector 1318, a digital signal processor (DSP) 1320, a user interface 1322, and a bus 1324. Alternatively, the functions associated with the transmitter 1310 and the receiver 1312 can be incorporated into a transceiver 1314. The wireless communication device can be configured to communicate in a wireless network that includes, for example, a base station, an access point, and the like.

In some aspects, the processor 1304 can be configured to control operations associated with the wireless communication device, wherein the processor 1304 may also be referred to as a central processing unit (CPU). The memory 1306 can be coupled to the processor 1304, can be in communication with the processor 1304, and can provide instructions and data to the processor 1304. The processor 1304 can perform logical and arithmetic operations based on program instructions stored within the memory 1306. The instructions in the memory 1306 can be executable to perform one or more methods and processes described herein. Furthermore, in some aspects, the processor 1304 can include, or be a component in, a processing system implemented with one or more processors. The one or more processors can be implemented with any one or more general-purpose microprocessors, microcontrollers, DSPs, field programmable gate array (FPGAs), programmable logic devices (PLDs), controllers, state machines, gated logic, discrete hardware components, dedicated hardware finite state machines, combinations thereof, and/or any other suitable entities that can perform calculations and/or manipulate information. In some aspects, the processing system can also include machine-readable media configured to store software, which can be broadly construed to include any suitable instructions, whether referred to as software, firmware, middleware, microcode, hardware description language, or otherwise. Instructions can include code in a source code format, a binary code format, an executable code format, and/or any other suitable format. The instructions, when executed on the one or more processors, can cause the processing system to perform one or more of the functions described herein.

In some aspects, the memory 1306 can include read-only memory (ROM), random access memory (RAM), and/or any suitable combination thereof. The memory 1306 can also include non-volatile random access memory (NVRAM).

In some aspects, the transmitter 1310 and the receiver 1312 (or the transceiver 1314) can transmit and receive data between the wireless communication device and a remote location. The antenna 1316 can be attached to the housing 1308 and electrically coupled to the transceiver 1314. In some implementations, the wireless communication device can also include multiple transmitters, multiple receivers, multiple transceivers, and/or multiple antennas (not illustrated). In some aspects, the signal detector 1318 can be used to detect and quantify the level associated with one or more signals received at the transceiver 1314. The signal detector 1318 can detect such signals as total energy, energy per subcarrier per symbol, power spectral density, and/or and in other ways. In some aspects, the DSP 1320 can be used to process signals, wherein the DSP 1320 can be configured to generate a packet to be transmitted via the transmitter 1310 and/or the transceiver 1314. In some aspects, the packet can include a physical layer protocol data unit (PPDU).

In some aspects, the user interface 1322 can include, for example, a keypad, a microphone, a speaker, a display, and/or other suitable interfaces. The user interface 1322 can include any element or component that conveys information to a user associated with the wireless communication device and/or receives input from the user.

In some aspects, the various components associated with the wireless communication device can be coupled together via a bus 1324, which may include a data bus and a power bus, a control signal bus, and/or a status signal bus in addition to the data bus.

In some aspects, the wireless communication device can also include other components or elements not illustrated in FIG. 13. One or more components associated with the wireless communication device can be in communication with another one or more components associated with the wireless communication device via means that may comprise another communication channel (not illustrated) to provide, for example, an input signal to the other component.

In some aspects, although various separate components are illustrated in FIG. 13, one or more components shown therein can be combined or commonly implemented. For example, the processor 1304 and the memory 1306 can be embodied on a single chip. The processor 1304 can additionally, or in the alternative, contain memory, such as processor registers. Similarly, one or more functional blocks or portions thereof can be embodied on a single chip. Alternatively, the functionality associated with a particular block can be implemented on two or more chips. For example, the processor 1304 can be used to implement not only the functionality described above with respect to the processor 1304, but also to implement the functionality described above with respect to the signal detector 1318 and/or the DSP 1320.

In some aspects, the wireless communication device includes means for configuring a short-range wireless communication link for use by a first communication technology, wherein a configuration of the short-range wireless communication link includes a number of configured retransmission opportunities to support multiple coexistence transmission patterns associated with the first communication technology and a second communication technology; and/or means for transmitting, to another wireless communication device, a communication using at least one of the first communication technology and the second communication technology based at least in part on a selected coexistence transmission pattern, of the multiple coexistence transmission patterns. In some aspects, the means for the wireless communication device to perform operations described herein may include, for example, one or more of processor 1304, memory 1306, transmitter 1310, receiver 1312, antenna 1316 DSP 1320, or bus 1324.

As indicated above, FIG. 13 is provided as an example. Other examples may differ from what is described with regard to FIG. 13.

The following provides an overview of some Aspects of the present disclosure:

Aspect 1: A method of wireless communication performed by a wireless communication device, comprising: configuring a short-range wireless communication link for use by a first communication technology, wherein a configuration of the short-range wireless communication link includes a number of configured retransmission opportunities to support multiple coexistence transmission patterns associated with the first communication technology and a second communication technology; and transmitting, to another wireless communication device, a communication using at least one of the first communication technology and the second communication technology based at least in part on a selected coexistence transmission pattern, of the multiple coexistence transmission patterns.

Aspect 2: The method of Aspect 1, wherein one of the first communication technology and the second communication technology is associated with BLE.

Aspect 3: The method of any of Aspects 1-2, wherein one of the first communication technology and the second communication technology is associated with a WLAN.

Aspect 4: The method of any of Aspects 1-3, further comprising selecting the selected coexistence transmission pattern, of the multiple coexistence transmission patterns.

Aspect 5: The method of any of Aspects 1-4, wherein the short-range wireless communication link is associated with an ISO interval comprising multiple subevents.

Aspect 6: The method of Aspect 5, wherein the selected coexistence transmission pattern includes multiple groups of one or more subevents dedicated for use by the first communication technology and multiple groups of one or more subevents dedicated for use by the second communication technology.

Aspect 7: The method of Aspect 6, wherein the multiple groups of one or more subevents dedicated for use by the first communication technology are distributed across the ISO interval such that a group of one or more subevents dedicated for use by the second communication technology is interspersed between each group of the multiple groups of one or more subevents dedicated for use by the first communication technology.

Aspect 8: The method of Aspect 7, wherein transmitting the communication using at least one of the first communication technology and the second communication technology based at least in part on the selected coexistence transmission pattern includes transmitting a set of data packets.

Aspect 9: The method of Aspect 8, wherein a first data packet, of the set of data packets, is transmitted using a first group of the multiple groups of one or more subevents dedicated for use by the first communication technology, and wherein a second data packet, of the set of data packets, is transmitted using a second group of the multiple groups of one or more subevents dedicated for use by the first communication technology.

Aspect 10: The method of any of Aspects 7-9, wherein a duration of each group of the multiple groups of one or more subevents dedicated for use by the first communication technology is less than a duration threshold.

Aspect 11: The method of Aspect 5, wherein the selected coexistence transmission pattern includes a first group of one or more subevents dedicated for use by the first communication technology and a second group of one or more subevents dedicated for use by the second communication technology.

Aspect 12: The method of Aspect 11, wherein a duration of the second group of one or more subevents dedicated for use by the second communication technology is greater than a duration threshold.

Aspect 13: The method of any of Aspects 11-12, wherein the first group of one or more subevents occurs at a beginning portion of the ISO interval and the second group of one or more subevents occurs at an ending portion of the ISO interval.

Aspect 14: The method of any of Aspects 11-13, wherein each subevent of the second group of one or more subevents occurs during a configured retransmission opportunity.

Aspect 15: The method of any of Aspects 11-14, wherein the second group of one or more subevents is associated with a first number of subevents in a first ISO interval, and wherein the second group of one or more subevents is associated with a second number of subevents, different than the first number of subevents, in a second ISO interval.

Aspect 16: The method of Aspect 15, wherein the second number of subevents is less than the first number of subevents.

Aspect 17: The method of any of Aspects 15-16, further comprising reducing the first number of subevents to the second number of subevents based at least in part on detecting a link quality associated with the first communication technology.

Aspect 18: The method of any of Aspects 15-17, further comprising changing the first number of subevents to the second number of subevents based at least in part on a demand for at least one of the first communication technology or the second communication technology.

Aspect 19: The method of any of Aspects 11-18, wherein at least one of the first communication technology is associated with a power-saving mode during the second group of one or more subevents, or the second communication technology is associated with a power-saving mode during the first group of one or more subevents.

Aspect 20: The method of any of Aspects 5-19, wherein the selected coexistence transmission pattern is associated with a maximum number of subevents, and wherein a number of subevents of the ISO interval is smaller than the maximum number of subevents associated with the coexistence transmission pattern.

Aspect 21: The method of Aspect 20, further comprising selecting a flush timeout associated with the ISO interval based at least in part on the number of subevents of the ISO interval.

Aspect 22: The method of any of Aspects 1-21, wherein the selected coexistence transmission pattern includes at least a portion of a first ISO interval dedicated for use by the first communication technology and at least a portion of a second ISO interval dedicated for use by the second communication technology.

Aspect 23: The method of any of Aspects 1-22, wherein the selected coexistence transmission pattern includes multiple isochronous intervals dedicated for use by one of the first communication technology or the second communication technology.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
configure a short-range wireless communication link for use by a first communication technology, wherein a configuration of the short-range wireless communication link includes a number of configured retransmission opportunities to support multiple coexistence transmission patterns associated with the first communication technology and a second communication technology; and
transmit, to another wireless communication device, a communication using at least one of the first communication technology and the second communication technology based at least in part on a selected coexistence transmission pattern, of the multiple coexistence transmission patterns.

2. The wireless communication device of claim 1, wherein one of the first communication technology and the second communication technology is associated with Bluetooth Low Energy (BLE).

3. The wireless communication device of claim 1, wherein one of the first communication technology and the second communication technology is associated with a wireless local area network (WLAN).

4. The wireless communication device of claim 1, wherein the one or more processors are further configured to select the selected coexistence transmission pattern, of the multiple coexistence transmission patterns.

5. The wireless communication device of claim 1, wherein the short-range wireless communication link is associated with an isochronous (ISO) interval comprising multiple subevents.

6. The wireless communication device of claim 5, wherein the selected coexistence transmission pattern includes multiple groups of one or more subevents dedicated for use by the first communication technology and multiple groups of one or more subevents dedicated for use by the second communication technology.

7. The wireless communication device of claim 6, wherein the multiple groups of one or more subevents dedicated for use by the first communication technology are distributed across the ISO interval such that a group of one or more subevents dedicated for use by the second communication technology is interspersed between each group of the multiple groups of one or more subevents dedicated for use by the first communication technology.

8. The wireless communication device of claim 7, wherein the one or more processors, to transmit the communication using at least one of the first communication technology and the second communication technology based at least in part on the selected coexistence transmission pattern, are configured to transmit a set of data packets.

9. The wireless communication device of claim 8, wherein the one or more processors, to transmit the communication using at least one of the first communication technology and the second communication technology based at least in part on the selected coexistence transmission pattern, are configured to:
transmit a first data packet, of the set of data packets, using a first group of the multiple groups of one or more subevents dedicated for use by the first communication technology; and
transmit a second data packet, of the set of data packets, using a second group of the multiple groups of one or more subevents dedicated for use by the first communication technology.

10. The wireless communication device of claim 7, wherein a duration of each group of the multiple groups of one or more subevents dedicated for use by the first communication technology is less than a duration threshold.

11. The wireless communication device of claim 5, wherein the selected coexistence transmission pattern includes a first group of one or more subevents dedicated for use by the first communication technology and a second group of one or more subevents dedicated for use by the second communication technology.

12. The wireless communication device of claim 11, wherein a duration of the second group of one or more subevents dedicated for use by the second communication technology is greater than a duration threshold.

13. The wireless communication device of claim 11, wherein the first group of one or more subevents occurs at a beginning portion of the ISO interval and the second group of one or more subevents occurs at an ending portion of the ISO interval.

14. The wireless communication device of claim 11, wherein each subevent of the second group of one or more subevents occurs during a configured retransmission opportunity.

15. The wireless communication device of claim 11, wherein the second group of one or more subevents is associated with a first number of subevents in a first ISO interval, and wherein the second group of one or more subevents is associated with a second number of subevents, different than the first number of subevents, in a second ISO interval.

16. The wireless communication device of claim 15, wherein the second number of subevents is less than the first number of subevents.

17. The wireless communication device of claim 15, wherein the one or more processors are further configured to reduce the first number of subevents to the second number of subevents based at least in part on detecting a link quality associated with the first communication technology.

18. The wireless communication device of claim 15, wherein the one or more processors are further configured to change the first number of subevents to the second number of subevents based at least in part on a demand for at least one of the first communication technology or the second communication technology.

19. The wireless communication device of claim 11, wherein at least one of the first communication technology is associated with a power-saving mode during the second group of one or more subevents, or the second communication technology is associated with a power-saving mode during the first group of one or more subevents.

20. The wireless communication device of claim 5, wherein the selected coexistence transmission pattern is associated with a maximum number of subevents, and wherein a number of subevents of the ISO interval is smaller than the maximum number of subevents associated with the coexistence transmission pattern.

21. The wireless communication device of claim 20, wherein the one or more processors are further configured to select a flush timeout associated with the ISO interval based at least in part on the number of subevents associated with one of the ISO interval or the coexistence transmission pattern.

22. The wireless communication device of claim 1, wherein the selected coexistence transmission pattern includes at least a portion of a first isochronous (ISO) interval dedicated for use by the first communication technology and at least a portion of a second ISO interval dedicated for use by the second communication technology.

23. The wireless communication device of claim 1, wherein the selected coexistence transmission pattern includes multiple isochronous intervals dedicated for use by one of the first communication technology or the second communication technology.

24. A method of wireless communication performed by a wireless communication device, comprising:
configuring a short-range wireless communication link for use by a first communication technology, wherein a configuration of the short-range wireless communication link includes a number of configured retransmission opportunities to support multiple coexistence transmission patterns associated with the first communication technology and a second communication technology; and
transmitting, to another wireless communication device, a communication using at least one of the first communication technology and the second communication technology based at least in part on a selected coexistence transmission pattern, of the multiple coexistence transmission patterns.

25. The method of claim 24, wherein the short-range wireless communication link is associated with an isochronous (ISO) interval comprising multiple subevents.

26. The method of claim 25, wherein the selected coexistence transmission pattern includes multiple groups of one or more subevents dedicated for use by the first communication technology and multiple groups of one or more subevents dedicated for use by the second communication technology.

27. The method of claim 26, wherein the multiple groups of one or more subevents dedicated for use by the first communication technology are distributed across the ISO interval such that a group of one or more subevents dedicated for use by the second communication technology is interspersed between each group of the multiple groups of one or more subevents dedicated for use by the first communication technology.

28. A non-transitory computer-readable medium storing a set of instructions for wireless communication, the set of instructions comprising:
one or more instructions that, when executed by one or more processors of a wireless communication device, cause the wireless communication device to:
configure a short-range wireless communication link for use by a first communication technology, wherein a configuration of the short-range wireless communication link includes a number of configured retransmission opportunities to support multiple coexistence transmission patterns associated with the first communication technology and a second communication technology; and
transmit, to another wireless communication device, a communication using at least one of the first communication technology and the second communication technology based at least in part on a selected coexistence transmission pattern, of the multiple coexistence transmission patterns.

29. The non-transitory computer-readable medium of claim 28, wherein one of the first communication technology and the second communication technology is associated with Bluetooth Low Energy (BLE), and wherein the other one of the first communication technology and the second communication technology is associated with a wireless local area network (WLAN).

30. An apparatus for wireless communication, comprising:
means for configuring a short-range wireless communication link for use by a first communication technology, wherein a configuration of the short-range wireless communication link includes a number of configured retransmission opportunities to support multiple coexistence transmission patterns associated with the first communication technology and a second communication technology; and
means for transmitting, to a wireless communication device, a communication using at least one of the first communication technology and the second communication technology based at least in part on a selected coexistence transmission pattern, of the multiple coexistence transmission patterns.
